(19) United States
(12) Patent Application Publication
(10) Pub. No.: US 2002/0048734 A1
(43) Pub. Date: Apr. 25, 2002

(54) Photothermographic material

(76) Inventors: Kouta Fukui, Minami Ashigara-shi (JP); Masaru Takasaki, Minami Ashigara-shi (JP); Katsuyuki Watanabe, Minami Ashigara-shi (JP)

Correspondence Address: BIRCH STEWART KOLASCH & BIRCH, PO BOX 747, FALLS CHURCH, VA, 22040-0747, US

(21) Appl. No.: 09/928,520

(22) Filed: Aug. 14, 2001

(30) Foreign Application Priority Data
Aug. 14, 2000 (JP) P. 2000-245689

(51) Int. Cl. G03C 1/498; G03C 1/34

(52) U.S. Cl. 430/620; 430/607; 430/613

(57) ABSTRACT

The object of the invention is to provide a photothermographic material high in sensitivity and image quality, and excellent in storability in the undeveloped state, which is used for medical images or photomechanical processes.

A photothermographic material is described, which comprises a support having provided on one side thereof at least one light-sensitive silver halide, light-insensitive organic silver salt, reducing agent for a silver ion and binder, in which the light-sensitive silver halide has an average grain size of 0.001 μm to 0.06 μm, and the material comprises at least two kinds of organic polyhalogen compounds, at least one of which is an organic polyhalogen compound represented by the following formula (1):

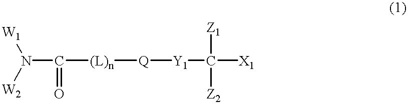

wherein Z₁ and Z₂ each independently represents a halogen atom, X₁ represents a hydrogen atom or an electron attractive group, Y₁ represents a —CO— group or an —SO₂— group, Q represents an arylene group or a divalent heterocyclic group, L represents a connecting group, W₁ and W₂ each independently represents a hydrogen atom, an alkyl group, an aryl group or a heterocyclic group, and n represents an integer of 0 or 1.

### FIELD OF THE INVENTION

The present invention relates to a photothermographic material.

### BACKGROUND OF THE INVENTION

In the recent medical field and photomechanical process field, it has been eagerly desired to reduce the amount of processing waste fluid, from the viewpoints of environmental preservation and space saving. Accordingly, techniques relating to photothermographic materials for medical diagnosis and photographic technique applications have been required which can be efficiently exposed with a laser image setter or a laser imager and can form black images having high resolution and sharpness. These photothermographic materials can dispense with the use of processing chemicals of the solution system represented by developing solutions, so that it becomes possible to provide to customers heat development processing systems which are simpler and do not damage the environment.

There is also a similar demand in the field of general image forming materials. However, images for medical use particularly require fine depictions, so that high image quality excellent in sharpness and granularity is necessary. Moreover, they are characterized by that blue black tone images are preferred from the viewpoint of ease of diagnosis. At present, various kinds of hard copy systems utilizing dyes or pigments, such as ink jet printers and electrophotogarphy, are in circulation as general image forming systems. However, there is no satisfactory system as an output system of medical images.

On the other hand, heat image forming systems utilizing organic silver salts are described, for example, in U.S. Pat. Nos. 3,152,904 and 3,457,075, and D. Klosterboer, Thermally Processed Silver Systems (Imaging Processes and Materials), Neblette, the eighth edition, edited by J. Sturge, V. Walworth and A. Shepp, chapter 9, page 279 (1989). In particular, photothermographic materials generally have image forming layers (light-sensitive layers) in which catalytic active amounts of photocatalysts (for example, silver halides), reducing agents, reducible silver salts (for example, organic silver salts) and optionally color toning agents for controlling a color tone of silver are dispersed in binder matrixes. After image exposure, the photothermographic materials are heated to a high temperature (or example, 80° C. or more) to form black silver images by the oxidation-reduction reaction between silver halides or the reducible silver salts (which act as oxidizing agents) and the reducing agents. The oxidation-reduction reaction is promoted by the catalytic function of latent images of silver halides generated by exposure. The black silver images are therefore formed in exposed regions. These are disclosed in many literatures including U.S. Pat. No. 2,910,377 and JP-B-43-4924 (the term “JP-B” as used herein means an “examined Japanese patent publication”). These heat image forming systems utilizing organic silver salts can achieve image quality and color tones satisfied as the images for medical use.

In these heat image forming systems utilizing organic silver salts, it has been discovered that a reduction in grain size of the silver halides causes an increase in development initiation points, thereby increasing the sensitivity. However, the reduction in grain size raises the problem that the sensitivity is largely decreased when light-sensitive materials are stored at high temperature (for example, at 60° C. for 7 hours).

### SUMMARY OF THE INVENTION

An object of the invention is to solve the above-mentioned problem of the conventional art. More specifically, an object of the invention is to provide a photothermographic material used for medical images, photomechanical processes or the like, which is high in sensitivity and excellent in storability (particularly, storability at high temperature) in the undeveloped state.

The present inventors have conducted intensive investigation for solving the above-mentioned problem, and have completed the invention.

That is to say, the invention provides a photothermographic material comprising a support having provided on one side thereof at least one light-sensitive silver halide, light-insensitive organic silver salt, reducing agent for a silver ion and binder, in which the light-sensitive silver halide has an average grain size of 0.001 μm to 0.06 μm, and the material comprises at least two kinds of organic polyhalogen compounds, at least one of which is an organic polyhalogen compound represented by the following formula (1):

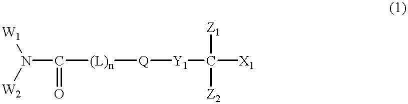

wherein Z₁ and Z₂ each independently represents a halogen atom, X₁ represents a hydrogen atom or an electron attractive group, Y₁ represents a —CO— group or an —SO₂— group, Q represents an arylene group or a divalent heterocyclic group, L represents a connecting group, W₁ and W₂ each independently represents a hydrogen atom, an alkyl group, an aryl group or a heterocyclic group, and n represents an integer of 0 or 1.

According to a preferred embodiment of the invention, there is provided the photothermographic material described above, wherein a layer containing the organic polyhalogen compound represented by formula (1) is formed by an aqueous coating solution, and the organic polyhalogen compound represented by formula (1) is added to the aqueous coating solution as an aqueous dispersion.

### DETAILED DESCRIPTION OF THE INVENTION

In the photothermographic material of the invention, at least two kinds of organic polyhalogen compounds are used. At least one of them is the organic polyhalogen compound represented by formula (1), and the other(s) is preferably a compound or compounds represented by the following formula (II):

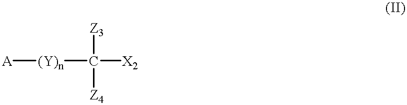

wherein A represents an alkyl group, an aryl group or a heterocyclic group, Z₃ and Z₄ each independently represents a halogen atom, X₂ represents a hydrogen atom or an electron attractive group, Y represents —C(═O)—, —SO— or —SO₂—, and n represents 0 or 1.

The aryl group represented by A may be either of a monocyclic group and a condensed ring group. Preferred is a monocyclic or bicyclic aryl group having from 6 to 30 carbon atoms (e.g., phenyl, naphthyl), more preferred is phenyl or naphthyl, and still more preferred is phenyl.

The heterocyclic group represented by A is a 3- to 10-membered saturated or unsaturated heterocyclic group containing at least one of N, O and S atoms, which may either be monocyclic or further form a condensed ring with another ring. As the heterocyclic group, a 5- or 6-membered unsaturated heterocyclic group which may have a condensed ring can be preferably used, and a 5- or 6-membered aromatic heterocyclic group which may have a condensed ring is more preferred. Still more preferred is a 5- or 6-membered nitrogen-containing aromatic heterocyclic group, and particularly preferred is a 5- or 6-membered aromatic heterocyclic group containing 1 to 4 nitrogen atoms, which may have a condensed ring.

Specific examples of the heterocyclic rings in the heterocyclic groups include, for example, pyrrolidine, piperidine, piperazine, morpholino, thiophene, furan, pyrrole, imidazole, pyrazole, pyridine, pyrimidine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, benzoselenazole, indolenine and tetraazaindene. As the heterocyclic rings, preferred are imidazole, pyrazole, pyridine, pyrimidine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine and tetraazaindene, more preferred are imidazole, pyridine, pyrimidine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole and tetraazaindene, still more preferred are imidazole, pyridine, pyrimidine, pyrazine, pyridazine, triazole, triazine, thiadiazole, quinoline, phthalazine, naphthyridine, quinoxaline, quinazoline, cinnoline, tetrazole, thiazole, benzimidazole and benzthiazole, and particularly preferred are pyridine, thiadiazole, quinoline and benzthiazole.

The aryl group or the heterocyclic group represented by A may have a substituent group other than —(Y)ₙ—C(X₂)(Z₃)(Z₄). Examples of the substituent groups include an alkyl group (having preferably from 1 to 20 carbon atoms, more preferably from 1 to 12 carbon atoms, and particularly preferably from 1 to 8 carbon atoms, e.g., methyl, ethyl, n-propyl, iso-propyl, n-butyl, iso-butyl, tert-butyl, n-octyl, n-decyl, n-hexadecyl, cyclopropyl, cyclopentyl, cyclohexyl), an alkenyl group (having preferably from 2 to 20 carbon atoms, more preferably from 2 to 12 carbon atoms, and particularly preferably from 2 to 8 carbon atoms, e.g., vinyl, allyl, 2-butenyl, 3-pentenyl), an alkynyl group (having preferably from 2 to 20 carbon atoms, more preferably from 2 to 12 carbon atoms, and particularly preferably from 2 to 8 carbon atoms, e.g., propargyl, 3-pentynyl), an aryl group (having preferably from 6 to 30 carbon atoms, more preferably from 6 to 20 carbon atoms, and particularly preferably from 6 to 12 carbon atoms, e.g., phenyl, p-methylphenyl, naphthyl), an amino group (having preferably from 0 to 20 carbon atoms, more preferably from 0 to 10 carbon atoms, and particularly preferably from 0 to 6 carbon atoms, e.g., amino, methylamino, dimethylamino, diethylamino, dibenzylamino), an alkoxyl group (having preferably from 1 to 20 carbon atoms, more preferably from 1 to 12 carbon atoms, and particularly preferably from 1 to 8 carbon atoms, e.g., methoxy, ethoxy, butoxy) , an aryloxy group (having preferably from 6 to 20 carbon atoms, more preferably from 6 to 16 carbon atoms, and particularly preferably from 6 to 12 carbon atoms, e.g., phenyloxy, 2-naphtyloxy), an acyl group (having preferably from 1 to 20 carbon atoms, more preferably from 1 to 16 carbon atoms, and particularly preferably from 1 to 12 carbon atoms, e.g., acetyl, benzoyl, formyl, pivaloyl), an alkoxycarbonyl group (having preferably from 2 to 20 carbon atoms, more preferably from 2 to 16 carbon atoms, and particularly preferably from 2 to 12 carbon atoms, e.g., methoxycarbonyl, ethoxycarbonyl), an aryloxycarbonyl group (having preferably from 7 to 20 carbon atoms, more preferably from 7 to 16 carbon atoms, and particularly preferably from 7 to 10 carbon atoms, e.g., phenyloxycarbonyl), an acyloxy group (having preferably from 2 to 20 carbon atoms, more preferably from 2 to 16 carbon atoms, and particularly preferably from 2 to 10 carbon atoms, e.g., acetoxy, benzoyloxy), an acylamino group (having preferably from 2 to 20 carbon atoms, more preferably from 2 to 16 carbon atoms, and particularly preferably from 2 to 10 carbon atoms, e.g., acetylamio, benzoylamino), an alkoxycarbonylamino group (having preferably from 2 to 20 carbon atoms, more preferably from 2 to 16 carbon atoms, and particularly preferably from 2 to 12 carbon atoms, e.g., methoxycarbonylamino), an aryloxycarbonylamino group (having preferably from 7 to 20 carbon atoms, more preferably from 7 to 16 carbon atoms, and particularly preferably from 7 to 12 carbon atoms, e.g., phenyloxycarbonylamino), a sulfonylamino group (having preferably from 1 to 20 carbon atoms, more preferably from 1 to 16 carbon atoms, and particularly preferably from 1 to 12 carbon atoms, e.g., methanesulfonylamino, benzenesulfonylamino), a sulfamoyl group (having preferably from 0 to 20 carbon atoms, more preferably from 0 to 16 carbon atoms, and particularly preferably from 0 to 12 carbon atoms, e.g., sulfamoyl, methylsulfamoyl, dimethylsulfamoyl, phenylsulfamoyl), a carbamoyl group (having preferably from 1 to 20 carbon atoms, more preferably from 1 to 16 carbon atoms, and particularly preferably from 1 to 12 carbon atoms, e.g., carbamoyl, methylcarbamoyl, diethylcarbamoyl, phenyl-carbamoyl), an alkylthio group (having preferably from 1 to 20 carbon atoms, more preferably from 1 to 16 carbon atoms, and particularly preferably from 1 to 12 carbon atoms, e.g., methylthio, ethylthio), an arylthio group (having preferably from 6 to 20 carbon atoms, more preferably from 6 to 16 carbon atoms, and particularly preferably from 6 to 12 carbon atoms, e.g., phenylthio), a sulfonyl group (having preferably from 1 to 20 carbon atoms, more preferably from 1 to 16 carbon atoms, and particularly preferably from 1 to 12 carbon atoms, e.g., mesyl, tosyl, phenylsulfonyl), a sulfinyl group (having preferably from 1 to 20 carbon atoms, more preferably from 1 to 16 carbon atoms, and particularly preferably from 1 to 12 carbon atoms, e.g., methanesulfinyl, benzenesulfinyl), a ureido group (having preferably from 1 to 20 carbon atoms, more preferably from 1 to 16 carbon atoms, and particularly preferably from 1 to 12 carbon atoms, e.g., ureido, methylureido, phenylureido), a phosphoneamide group (having preferably from 1 to 20 carbon atoms, more preferably from 1 to 16 carbon atoms, and particularly preferably from 1 to 12 carbon atoms, e.g., diethylphosphoneamide, phenylphosphoneamide), a hydroxyl group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group and a heterocyclic group (e.g., imidazolyl, pyridyl, furyl, piperidyl, morpholino). These substituent groups may be further substituted. When there are two or more substituent groups, they may be the same or different.

The substituent groups are preferably an alkyl group, an alkenyl group, an aryl group, an alkoxyl group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, a sulfonyl group, a ureido group, a phosphoneamide group, a halogen atom, a cyano group, a sulfo group, a carboxyl group, a nitro group and a heterocyclic group, more preferably an alkyl group, an aryl group, an alkoxyl group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoneamide group, a halogen atom, a cyano group, a nitro group and a heterocyclic group, still more preferably an alkyl group, an aryl group, an alkoxyl group, an aryloxy group, an acyl group, an acylamino group, a sulfonylamino group, a sulfamoyl group, a carbamoyl group, a halogen atom, a cyano group, a nitro group and a heterocyclic group, and particularly preferably an alkyl group, an aryl group, a sulfamoyl group, a carbamoyl group and a halogen atom.

The alkyl group represented by A, which may be straight-chain, branched, cyclic or a combination thereof, has preferably from 1 to 30 carbon atoms, and more preferably from 1 to 15 carbon atoms. Examples thereof include methyl, ethyl, n-propyl, isopropyl and tert-octyl.

The alkyl group represented by A may have a substituent group other than —(Y)ₙ—C(X₂)(Z₃)(Z₄). The substituent groups include the same substituent groups as illustrated for the aryl group or the heterocyclic group represented by A. The substituent groups are preferably a carbamoyl group, a sulfamoyl group, an alkenyl group, an aryl group, an alkoxyl group, an aryloxy group, an acyloxy group, an acylamino group, an alkoxycarbonylamino group, an aryloxycarbonylamino group, a sulfonylamino group, an alkylthio, an arylthio group, a ureido group, a phosphoneamide group, a hydroxyl group, a halogen atom and a heterocyclic group, more preferably a carbamoyl group, a sulfamoyl group, an aryl group, an alkoxyl group, an aryloxy group, an acylamino group, an alkoxycarbonylamino group, an aryloxycarbonylamino group, a sulfonylamino group, a ureido group, a phosphoneamide group and a halogen atom, and still more preferably a carbamoyl group, a sulfamoyl group, an aryl group, an alkoxyl group, an aryloxy group, an acylamino group, a sulfonylamino group, a ureido group and a phosphoneamide group. These substituent groups may be further substituted. When there are two or more substituent groups, they may be the same or different.

Y represents —C(═O)—, —SO— or —SO₂—, preferably —C(═O)— or —SO₂—, and more preferably —SO₂—. n represents 0 or 1, and preferably 1. Z₃ and Z₄ each independently represents a halogen atom. The halogen atoms represented by Z₃ and Z₄, which may be the same or different, are, for example, fluorine, chlorine, bromine and iodine, preferably chlorine, bromine and iodine, more preferably chlorine and bromine, and particularly preferably bromine.

X₂ represents a hydrogen atom or an electron attractive group. The electron attractive group represented by X₂ is preferably a substituent group (including an atom) in which the σp value can take a positive value. Preferred is a substituent group having a σp value of 0.01 or more, and more preferred is a substituent group having a σp value of 0.1 or more. For the Hammett substituent constant, reference can be made to Journal of Medicinal Chemistry, 16 (11), 1207-1216 (1973). Examples of the electron attractive groups include a halogen atom (e.g., fluorine (σp value: 0.06), chlorine (σp value: 0.23), bromine (σp value: 0.23), iodine (σp value: 0.18)); a trihalomethyl group (e.g., tribromomethyl (σp value: 0.29), trichloromethyl (σp value: 0.33), trifluoromethyl (σp value: 0.54)); a cyano group (σp value: 0.66); a nitro group (σp value: 0.78); an aliphatic, aryl or heterocyclic sulfonyl group (e.g., methanesulfonyl (σp value: 0.72)); an aliphatic, aryl or heterocyclic acyl group (e.g., acetyl (σp value: 0.50), benzoyl (σp value: 0.43)); an alkynyl group (e. g., C≡CH (σp value: 0.23)); an aliphatic, aryl or heterocyclic oxycarbonyl group (e.g., methoxycarbonyl (σp value: 0.45), phenoxycarbonyl (σp value: 0.44)); a carbamoyl group (σp value: 0.36); and a sulfamoyl group (σp value: 0.57).

X₂ is preferably an electron attractive group, more preferably a halogen atom; an aliphatic, aryl or heterocyclic sulfonyl group; an aliphatic, aryl or heterocyclic acyl group; an aliphatic, aryl or heterocyclic oxycarbonyl group; a carbamoyl group; or sulfamoyl group, and particularly preferably a halogen atom. Of the halogen atoms, preferred are chlorine, bromine and iodine, more preferred are chlorine and bromine, and particularly preferred is bromine.

Preferred examples of the compounds represented by formula (II) include a compound represented by the following formula (II-a):

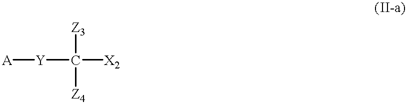

wherein A has the same meaning as given for formula (II) and a preferred range is also the same as described therefor. Substituent groups substitutable to A have the same meaning as given for formula (II). Z₃, Z₄, Y and X₂ each has the same meaning as given for formula (II), and preferred ranges are also the same as described therefor.

Of the compounds represented by formula (II), more preferred is a compound represented by formula (II-b):

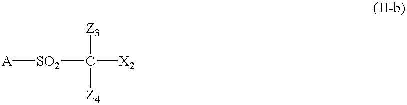

wherein A has the same meaning as given for formula (II), and a preferred range is also the same as described therefor. Substituent groups substitutable to A have the same meaning as given for formula (II). Z₃, Z₄ and X₂ each has the same meaning as given for formula (II), and preferred ranges are also the same as described therefor.

Specific examples of the compounds represented by formula (II) include specific examples II-1 to II-38 of the compounds represented by formula (II) of JP-A-10-339934 (the term “JP-A” as used herein means an “unexamined published Japanese patent application”).

The organic polyhalogen compounds represented by formula (1), which are used as an essential ingredient in the photothermographic material of the present invention, may be used as a combination of two or more of them. In formula (1), Z₁ and Z₂ each independently represents a halogen atom (e.g., fluorine, chlorine, bromine, iodine), and it is most preferred that both Z₁ and Z₂ are bromine atoms.

In formula (1), X₁ represents a hydrogen atom or an electron attractive group. As the electron attractive groups, there can be used ones illustrated for X₂ in formula (II). Preferred examples of the electron attractive groups include a cyano group, an alkoxycarbonyl group, an aryloxycarbonyl group, a carbamoyl group, a sulfamoyl group, an alkylsulfonyl group, an arylsulfonyl group, a halogen atom, an acyl group and a heterocyclic group. Preferred are a hydrogen atom and a halogen atom, and most preferred is bromine. In formula (1), Y₁ represents a —CO— group or an —SO₂— group, and preferred is an —SO₂— group.

In formula (1), Q represents an arylene group or a divalent heterocyclic group. The arylene group represented by Q of formula (1) is a monocyclic or condensed ring type arylene group preferably having from 6 to 30 carbon atoms, and more preferably having from 6 to 20 carbon atoms. Examples thereof include phenylene and naphthylene groups. Particularly preferred is a phenylene group. The arylene group represented by Q may have a substituent group, which may be any as long as it has no adverse effect on photographic characteristics. Examples thereof include a halogen atom (fluorine, chlorine, bromine or iodine), an alkyl group (including an aralkyl group, a cycloalkyl group and active methine group), an alkenyl group, alkynyl group, an aryl group, a heterocyclic group (including an N-substituted N-containing heterocyclic group, e.g., morpholino), a heterocyclic group containing a quaternized nitrogen atom (e.g., pyridinio), an acyl group, an alkoxycarbonyl group, an aryloxycarbonyl group, a carbamoyl group, a carboxyl group or a salt thereof, an imino group, an imino group substituted by a nitrogen atom, a thiocarbonyl group, a carbazoyl group, a cyano group, a thiocarbamoyl group, an alkoxyl group (including a group repeatedly containing an ethyleneoxy group or propyleneoxy group unit), an aryloxy group, a heterocyclic oxy group, an acyloxy group, an (alkoxy or aryloxy)carbonyloxy group, a sulfonyloxy group, an acylamino group, a sulfonamido group, a ureido group, a thioureido group, an imido group, an (alkoxy or aryloxy)carbonylamino group, a sulfamoylamino group, a semicarbazido group, a thiosemicarbazido group, a hydrazino group, a quaternary ammonio group, an (alkyl or aryl)sulfonylureido group, a nitro group, an (alkyl, aryl or heterocyclic)thio group, an acylthio group, an (alkyl or aryl)sulfonyl group, an (alkyl or aryl)sulfinyl group, a hydroxyl group, a sulfo group or a salt thereof, a sulfamoyl group, a phosphoryl group, a group containing a phosphoric acid amide or phosphoric ester structure and a silyl group. These substituent groups may be further substituted by these substituent groups themselves.

As the substituent groups for the arylene group represented by Q of formula (1), particularly preferred are an alkyl group, an alkoxyl group, an aryloxy group, a halogen atom, a carboxyl group or a salt thereof, a salt of a sulfo group and a phosphoric acid group.

In formula (1), the heterocyclic ring contained in the divalent heterocyclic group represented by Q is a 5- to 7-membered saturated or unsaturated heterocyclic ring containing at least one of N, O and S atoms, which may be either monocyclic or form a condensed ring together with another ring. The heterocyclic rings contained in the heterocyclic groups represented by Q include, for example, pyridine, pyrazine, pyrimidine, benzothiazole, benzimidazole, thiadiazole, quinoline, isoquinoline and triazole. These may have substituent groups, and examples thereof include the same groups as the substituent groups for the aryl group represented by Q.

Q of formula (1) is preferably an arylene group, and particularly preferably a phenylene group. When Q represents a phenylene group, —Y₁—C(X₁)(Z₁)(Z₂) and —(L)_{n—CON(W}₁)(W₂) are preferably bonded to Q at positions meta to each other.

L of formula (1) represents a divalent connecting group, and examples thereof include an alkylene group (having preferably 1 to 30 carbon atoms, more preferably 1 to 20 carbon atoms, and particularly preferably 1 to 10 carbon atoms), an arylene group (having preferably 6 to 30 carbon atoms, more preferably 6 to 20 carbon atoms, and particularly preferably 6 to 120 carbon atoms), an alkenylene group (having preferably 2 to 30 carbon atoms, more preferably 2 to 20 carbon atoms, and particularly preferably 2 to 10 carbon atoms), an alkynylene group (having preferably 2 to 30 carbon atoms, more preferably 2 to 20 carbon atoms, and particularly preferably 2 to 10 carbon atoms), a divalent heterocyclic group (having preferably 1 to 30 carbon atoms, more preferably 1 to 20 carbon atoms, and particularly preferably 1 to 10 carbon atoms), an —O— group, an —NR— group, a —CO— group, an —S— group, an —SO— group, an —SO₂— group, a phosphorus-containing group, and a group formed by a combination thereof (wherein a group represented by R is a hydrogen atom, an alkyl group which may have a substituent group, or an aryl group which may have a substituent group).

The connecting group represented by L of formula (1) may have a substituent group, and examples thereof include the same substituent groups as those for the arylene group represented by Q.

The connecting groups represented by L of formula (1) are preferably an alkylene group, an arylene group, an —O— group, an —NRCO— group, an —SO₂NR— group and a group formed by a combination thereof.

n of formula (1) is 0 or 1, and preferably 0.

In formula (1), W₁ and W₂ each independently represents a hydrogen atom, an alkyl group, an aryl group or a heterocyclic group.

The alkyl group represented by each of W₁ and W₂ of formula (1), which may be straight-chain, branched, cyclic or a combination thereof, has preferably from 1 to 20 carbon atoms, more preferably from 1 to 12 carbon atoms, and particularly preferably from 1 to 6 carbon atoms. Examples thereof include methyl, ethyl, allyl, n-propyl, isopropyl, n-butyl, sec-butyl, isobutyl, n-pentyl, sec-pentyl, isopentyl, 3-pentyl, n-hexyl, n-octyl, n-dodecyl and cyclohexyl.

The alkyl groups represented by W₁ and W₂ of formula (1) may have substituent groups, and examples thereof include the same substituent groups as those for the arylene group represented by Q. The substituent group for the alkyl group represented by each of W₁ and W₂ is preferably a halogen atom, an alkenyl group, an alkynyl group, an aryl group, a heterocyclic group, a carbamoyl group, an alkoxyl group, an aryloxy group, a sulfonamido group, an (alkyl or aryl)thio group, an (alkyl or aryl)sulfonyl group, a sulfo group or a salt thereof, a carboxyl group or a salt thereof, a phosphoric acid group or a salt thereof or a hydroxyl group, more preferably a halogen atom, an alkenyl group, an alkynyl group, an aryl group, a carbamoyl group, an alkoxyl group, an aryloxy group, an (alkyl or aryl)thio group, a sulfo group or a salt thereof, a carboxyl group or a salt thereof or a hydroxyl group, and particularly preferably a halogen atom, an alkenyl group, a carbamoyl group, an alkoxyl group, an alkylthio group, a salt of a sulfo group, a carboxyl group or a salt thereof or a hydroxyl group.

The aryl group represented by each of W₁ and W₂ of formula (1) is a monocyclic or condensed ring type aryl group having preferably from 6 to 20 carbon atoms, more preferably from 6 to 16 carbon atoms, and particularly preferably from 6 to 10 carbon atoms. Examples thereof include phenyl and naphthyl, and preferred is phenyl. The aryl groups represented by W₁ and W₂ may have substituent groups. Examples thereof include the same substituent groups as those for the alkyl groups represented by W₁ and W₂, and a preferred range is also the same as described therefor.

The heterocyclic ring represented by each of W₁ and W₂ of formula (1) is a 5- to 7-membered saturated or unsaturated heterocyclic ring containing at least one of N, O and S atoms, which may be either monocyclic or form a condensed ring together with another ring. Examples thereof include pyridyl, pyrazinyl, pyrimidinyl, thiazolyl, imidazolyl, benzothiazolyl, benzimidazolyl, thiadiazolyl, quinolyl, isoquinolyl and triazolyl. They may have substituent groups. Examples thereof include the same substituent groups as those for the alkyl groups represented by W₁ and W₂, and a preferred range is also the same as described therefor. W₁ and W₂ may be the same or different, and may be combined with each other to form a cyclic structure. W₁ and W₂ are each preferably a hydrogen atom, an alkyl group or an aryl group, and particularly preferably a hydrogen atom or an alkyl group.

Specific examples of the organic polyhalogen compounds represented by formula (1) are shown below, but the polyhalogen compounds applicable to the light-sensitive materials of the invention are not limited thereto.

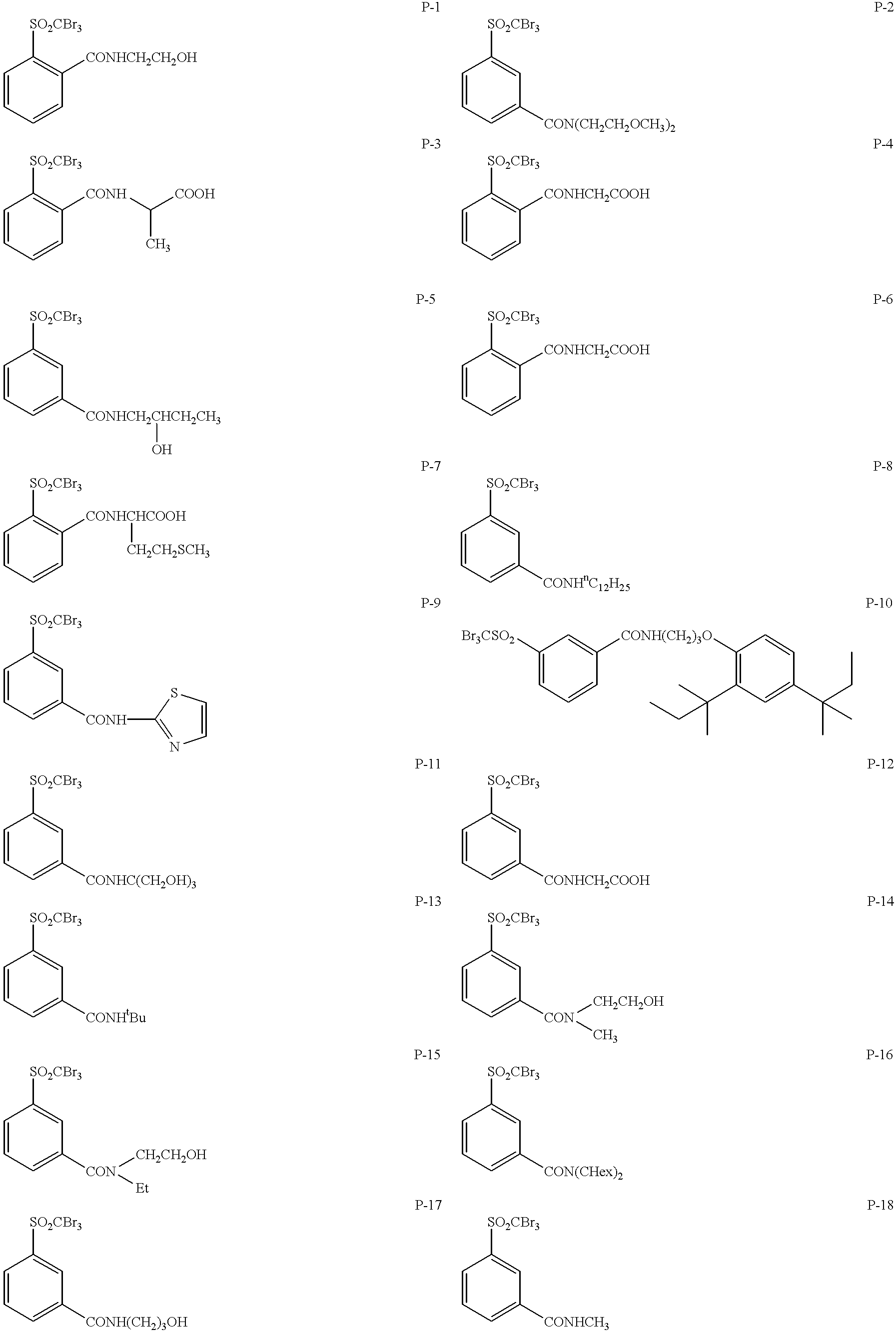

The above-mentioned organic polyhalogen compounds can be used as solutions thereof in water or appropriate organic solvents such as alcohols (methanol, ethanol, propanol and fluorinated alcohol), ketones (acetone, methyl ethyl ketone and methyl isobutyl ketone), dimethylformamide, dimethyl sulfoxide and methyl cellosolve. Further, compounds to which acidic groups are bonded may be added as salts neutralized with equivalent alkalis.

Layers containing the organic polyhalogen compounds represented by formula (1) are preferably formed by aqueous coating solutions, and the organic polyhalogen compounds represented by formula (1) are preferably used as aqueous dispersions in the aqueous coating solutions. As dispersion methods, any methods may be employed. The well-known emulsification dispersion methods include a method of dissolving the polyhalogen compounds using oils such as dibutyl phthalate, tricresyl phosphate, glyceryl triacetate and diethyl phthalate, and co-solvents such as ethyl acetate and cyclohexanone, and mechanically preparing emulsified dispersions. Further, the solid dispersion methods include a method of dispersing polyhalogen compound powders in appropriate solvents such as water in a ball mill or a colloid mill, or by a supersonic to prepare solid dispersions. In that case, protective colloids (e.g., polyvinyl alcohol) and surfactants (e.g., anionic surfactants such as sodium triisopropylnaphthalenesulfonate (a mixture of three isomers different in substitution positions of isopropyl groups)) may be used. The aqueous dispersions may contain preservatives (e.g., benzoisothiazolinone sodium salt). The particle size of the aqueous dispersions is preferably within the range of 0.1 μm to 1.0 μm, and more preferably within the range of 0.15 μm to 0.60 μm.

The amount of the organic polyhalogen compound added is from 1×10⁻⁶ mol to 1 mol, preferably from 1×10⁻⁵ mol to 0.5 mol, and more preferably from 1×10⁻³ mol to 0.3 mol, per mol of silver preferably on a side having an image forming layer. In this case, “per mol of silver” means “per mol of the total of silver halide and organic acid silver”. Although the organic polyhalogen compound may be added to a layer on the image forming layer side to a support, that is to say, the image forming layer or any other layer on this layer side, it is preferably added to the image forming layer or a layer adjacent thereto. The ratio of the organic polyhalogen compound other than the organic polyhalogen compound represented by formula (1) to the organic polyhalogen compound represented by formula (1) used in combination therewith is preferably between 0.01:99.99 and 99.99:0.01, more preferably between 5:95 and 95:5, and still more preferably between 9:91 and 91:9.

The organic silver salt which can be used in the invention is relatively stable to light, and is a silver salt forming a silver image when heated to a temperature of 80° C. or more in the presence of an exposed photocatalyst (such as a latent image of a light-sensitive silver halide) and a reducing agent. The organic silver salt may be any organic substance containing a source which can reduce a silver ion. Such light-insensitive organic silver salts are described in JP-A-10-62899, paragraph numbers 0048 to 0049 and EP-A-0803763, page 18, line 24 to page 19, line 37. A silver salt of an organic acid, particularly a silver salt of a long-chain aliphatic carboxylic acid (having from 10 to 30 carbon atoms, and preferably from 15 to 28 carbon atoms), is preferred. Preferred examples of the organic silver salts include silver behenate, silver arachidate, silver stearate, silver oleate, silver laurate, silver caproate, silver myristate, silver palmitate, silver maleate, silver fumarate, silver tartrate, silver linoleate, silver butyrate, silver camphorate and mixtures thereof.

Although there is no particular limitation on the form of the organic silver salt which can be used in the invention, a scaly organic silver salt is preferred in the invention. In this specification, the term “scaly organic silver salt” is defined as follows. The organic acid silver salt is observed under an electron microscope, and the form of an organic acid silver salt particle is approximated to a rectangular parallelepiped. When the sides of this rectangular parallelepiped are taken as a, b and c from the shortest one (c may be equal to b), x is determined according to the following equation from shorter numerical values a and b:

X=b/a

x is determined in this manner for about 200 particles, and the average value thereof is taken as x (average). The particles satisfying the relationship of x (average)≧1.5 are defined as scaly particles. The relationship is preferably 30≧x (average)≧1.5, and more preferably 20≧x (average)≧2.0. By the way, when 1≦x (average)<1.5 is satisfied, the particles are defined as acicular particles.

In the scaly particle, a can be considered as the thickness of a tabular particle in which a plane having sides b and c is a main plane. The average of a is preferably from 0.01 μm to 0.23 μm, and more preferably from 0.1 μm to 0.20 μm. The average of c/b is preferably from 1 to 6, more preferably from 1.05 to 4, still more preferably from 1.1 to 3, and particularly preferably from 1.1 to 2.

It is preferred that the organic silver salt has monodisperse particle size distribution. The term “monodisperse” means that the percentage of a value of the standard deviation of each length of the short and long axes divided by each the short and long axes is preferably 100% or less, more preferably 80% or less, and still more preferably 50% or less. The form of the organic silver salt can be determined from an image of an organic silver salt dispersion observed under a transmission electron microscope. As another method for measuring the monodispersibility, there is a method of determining the standard deviation of volume weighted average diameters of the organic silver salt. The percentage (the coefficient of variation) of values dividing the standard deviation by volume weighted average diameters is preferably 100% or less, more preferably 80% or less, and still more preferably 50% or less. This can be determined, for example, from particle sizes (volume weighted average diameters) determined by irradiating laser light to the organic silver salt dispersed in a solution and determining the autocorrelation function to changes in fluctuation of its scattered light with time.

The organic acid silver salts used in the invention are prepared by reacting solutions or suspensions of organic acid alkali metal salts (including Na salts, K salts and Li salts) with silver nitrate. The organic acid alkali metal salts are obtained by the alkali treatment of the organic acids. The organic silver salt can be prepared in a batch-wise or continuous manner in any suitable vessel. The stirring in the reaction vessel is conducted by any stirring method depending on characteristics required for particles. As the method for preparing the organic acid silver salt, there can be preferably used all of a method of gradually or rapidly adding an aqueous solution of silver nitrate to a reaction vessel containing a solution or suspension of an organic acid alkali metal salt, a method of gradually or rapidly adding a solution or suspension of an organic acid alkali metal salt previously prepared to a reaction vessel containing an aqueous solution of silver nitrate, and a method of concurrently adding an aqueous solution of silver nitrate and a solution or suspension of an organic acid alkali metal salt previously prepared to a reaction vessel.

The aqueous solution of silver nitrate and the solution or suspension of the organic acid alkali metal salt can be used at arbitrary concentrations for controlling the particle size of the organic acid silver salt to be prepared, and added at arbitrary addition rates. The aqueous solution of silver nitrate and the solution or suspension of the organic acid alkali metal salt can be added by a method of adding them at constant addition rates, or by an acceleration addition method or deceleration addition method according to arbitrary function of time. They may be added onto a liquid surface of a reaction solution or into the reaction solution. In the case of the method of concurrently adding the aqueous solution of silver nitrate and the solution or suspension of the alkali metal salt of the organic acid previously prepared to the reaction vessel, the addition of either the aqueous solution of silver nitrate, or the solution or suspension of the organic acid alkali metal salt can also precede. It is preferred that the addition of the aqueous solution of silver nitrate precedes. The amount previously added is preferably from 0% to 50% by volume, and particularly preferably from 0% to 25% by volume, based on the total amount added. Further, as described in JP-A-9-127643, a method of adding them while adjusting the pH or silver potential of a reaction solution during reaction can also be preferably used.

The aqueous solution of silver nitrate and the solution or suspension of the organic acid alkali metal salt to be added can be adjusted in pH according to characteristics of particles required. Any acid or alkali can be added for pH adjustment. According to characteristics of particles required, for example, the temperature in the reaction vessel can be arbitrarily established for controlling the particle size of organic acid silver to be prepared. The aqueous solution of silver nitrate and the solution or suspension of the organic acid alkali metal salt to be added can also be adjusted to any temperatures. The solution or suspension of the organic acid alkali metal salt is preferably maintained at 50° C. or more by heating for ensuring the liquid fluidity.

The organic acid silver salts used in the invention are preferably prepared in the presence of tertiary alcohols. The total carbon number of the tertiary alcohols is preferably 15 or less, and more preferably 10 or less. Preferred examples of the tertiary alcohols include tert-butanol. Although the tertiary alcohol may be added at any time in preparing the organic acid silver salt, it is preferably added in preparing the organic acid alkali metal salt to dissolve the alkali metal salt. The amount of the tertiary alcohol used can be arbitrarily selected within the range of 0.01 to 10 by the weight ratio to water as a solvent in preparing the organic acid silver salt. However, it is preferably within the range of 0.03 to 1.

In the invention, the preferred scaly organic acid silver salt is preferably produced by a method in which when an aqueous solution containing a water-soluble silver salt is allowed to react with an aqueous solution of the tertiary alcohol containing the organic acid alkali metal salt in a reaction vessel (inclusive of a stage of adding the aqueous solution of the tertiary alcohol containing the organic acid alkali metal salt to the solution in the reaction vessel), the temperature difference between a solution in the reaction vessel and the aqueous solution of the tertiary alcohol containing the organic acid alkali metal salt to be added is from 20° C. to 85° C. In this case, the solution in the reaction vessel is preferably the aqueous solution containing the water-soluble silver salt previously placed in the reaction vessel. When the aqueous solution containing the water-soluble silver salt and the aqueous solution of the tertiary alcohol containing the organic acid alkali metal salt are concurrently added at the beginning without the preceding addition of the aqueous solution containing the water-soluble silver salt, the solution in the reaction vessel is water or a mixed solvent of water and the tertiary alcohol, as described later. Also in the case of the preceding addition of the aqueous solution containing the water-soluble silver salt, water or the mixed solvent of water and the tertiary alcohol may be previously placed in the reaction vessel.

The maintenance of such a temperature difference during the addition of the aqueous solution of the tertiary alcohol containing the organic acid alkali metal salt preferably control the crystal form of the organic acid silver salt.

As this water-soluble silver salt, silver nitrate is preferred, and the concentration of the water-soluble silver salt in the aqueous solution is preferably from 0.03 mol/liter to 6.5 mol/liter, and more preferably from 0.1 mol/liter to 5 mol/liter. The pH of this aqueous solution is preferably from 2 to 6, and more preferably from 3.5 to 6.

The aqueous solution of the water-soluble silver salt may contain a tertiary alcohol having from 4 to 6 carbon atoms. In that case, the amount of the tertiary alcohol contained is 70% or less, and preferably 50% or less by volume, based on the total volume of the aqueous solution of the water-soluble silver salt. Further, the temperature of the aqueous solution is preferably from 0°C. to 50° C., and more preferably from 5° C. to 30° C. When the aqueous solution containing the water-soluble silver salt and the aqueous solution of the tertiary alcohol containing the organic acid alkali metal salt are concurrently added, as described later, the temperature of the aqueous solution is most preferably from 5° C. to 15° C.

Alkali metals of the organic acid alkali metal salts are specifically Na and K. The organic acid alkali metal salts are prepared by adding NaOH or KOH to organic acids. At this time, it is preferred that the alkali is added in an amount equivalent to or less than the organic acids to allow the unreacted organic acids to remain. In this case, the remaining organic acid amount is from 3 mol % to 50 mol %, and preferably from 3 mol % to 30 mol %, per mol of the total organic acids. The organic acid alkali metal salts may also be prepared by adding the alkali in an amount desired or more, and then, adding an acid such as nitric acid or sulfuric acid to neutralize the excess alkali.

Further, the pH can be adjusted depending on characteristics required for the organic acid silver salts. For pH adjustment, any acids or alkalis can be used.

Furthermore, for example, a compound as represented by formula (1) of JP-A-62-65035, a water-soluble group-containing N-heterocyclic compound as described in JP-A-62-150240, an inorganic peroxide as described in JP-A-50-101019, a sulfur compound as described in JP-A-51-78319, a disulfide compound described in JP-A-57-643 or hydrogen peroxide can be added to the aqueous solution containing the water-soluble silver salt, the aqueous solution of the tertiary alcohol containing the organic acid alkali metal salt, or the solution in the reaction vessel.

In the aqueous solution of the tertiary alcohol containing the organic acid alkali metal salt, a mixed solvent of water and a tertiary alcohol having from 4 to 6 carbons is preferably used for obtaining the liquid uniformity. When the carbon number exceeds 4, the compatibility with water is unfavorably decreased. Of the tertiary alcohols having from 4 to 6 carbons, tert-butanol highest in the compatibility with water is most preferred. The other alcohols other than the tertiary alcohols are unfavorable as described above because of their reducibility which causes harmful effects in the formation of the organic acid silver salts. The amount of the tertiary alcohol used in combination with the aqueous solution of the tertiary alcohol containing the organic acid alkali metal salt is from 3% to 70%, and preferably from 5% to 50%, by solvent volume, based on the volume of water contained in the aqueous solution of the tertiary alcohol.

The concentration of the organic acid alkali metal salt in the aqueous solution of the tertiary alcohol containing the organic acid alkali metal salt is from 7% to 50% by weight, preferably from 7% to 45% by weight, and more preferably from 10% to 40% by weight.

The temperature of the aqueous solution of the tertiary alcohol containing the organic acid alkali metal salt to be added to the reaction vessel is preferably from 50° C. to 90° C., more preferably from 60° C. to 85° C., and most preferably from 65° C. to 85° C., for the purpose of keeping the organic acid alkali metal salt at a temperature necessary for avoiding the phenomenon of crystallization or solidification. Further, for controlling the reaction temperature constant, it is preferably controlled constant to a certain temperature selected from the range described above.

The organic acid silver salt preferably used in the invention is produced by i) a method of singly adding the aqueous solution of the tertiary alcohol containing the organic acid alkali metal salt to an aqueous solution containing the whole amount of the water-soluble silver salt-containing aqueous solution, which is previously placed in the reaction vessel, or ii) a method in which there is the time at which the aqueous solution of the water-soluble silver salt and the aqueous solution of the tertiary alcohol containing the organic acid alkali metal salt are concurrently added to the reaction vessel (a concurrent addition method). In the invention, the latter concurrent addition method is preferred in that the average particle size of the organic acid silver salt is controlled and that the distribution thereof is narrowed. In that case, it is preferred that 30% by volume or more of the total amount added is concurrently added. More preferably, 50% to 75% by volume is concurrently added. When either of them is previously added, the addition of the solution of the water-soluble silver salt is preferably allowed to precede.

In either case, the temperature of the solution in the reaction vessel is preferably from 5° C. to 75° C., more preferably from 5° C. to 60° C., and most preferably from 10° C. to 50° C., wherein the solution in the reaction vessel means the aqueous solution of the water-soluble silver salt previously added as described above, and when the aqueous a solution of the water-soluble silver salt is not previously added, it means the solvent previously placed in the reaction vessel as described later. Although it is preferred that the reaction is controlled to a certain constant temperature selected from the above-mentioned temperature range over the entire course thereof, it is also preferred that the reaction is controlled by several temperature patterns within the above-mentioned temperature range.

The temperature difference between the aqueous solution of the tertiary alcohol containing the organic acid alkali metal salt and the solution in the reaction vessel is preferably from 20° C. to 85° C., and more preferably from 30° C. to 80° C. In this case, it is preferred that the temperature of the aqueous solution of the tertiary alcohol containing the organic acid alkali metal salt is higher than that of the solution in the reaction vessel.

This can preferably control the rate at which the high-temperature aqueous solution of the tertiary alcohol containing the organic acid alkali metal salt is rapidly cooled in the reaction vessel to precipitate in the fine crystalline form and the rate at which the organic acid silver salt is formed by the reaction with the water-soluble silver salt to preferably control the crystalline form, crystalline size and crystalline size distribution of the organic acid silver salt. At the same time, when the organic acid silver salt is used in the heat-developable material, particularly the photothermographic material, the performance thereof can be more improved.

A solvent may be previously placed in the reaction vessel, and water is preferably used as the solvent. A mixed solvent with the above-mentioned tertiary alcohol is also preferably used.

An aqueous medium-soluble dispersing aid can be added to the aqueous solution of the tertiary alcohol containing the organic acid alkali metal salt, the aqueous solution of the water-soluble silver salt or the reaction solution. The dispersing aid may be any as long as it can disperse the organic acid silver salt formed. Specific examples thereof include dispersing aids for the organic acid silver salts described later.

In the preparation of the organic acid silver salt, desalting and dehydration are preferably performed after silver salt formation. There is no particular limitation on the method therefor, and well-known means can be used. There are used, for example, known filtering methods such as centrifugal filtration, suction filtration, ultrafiltration and flocculation washing by coagulation. Supernatant removal by centrifugal precipitation is also preferably used. The desalting and dehydration may be conducted once or repeated twice or more times. The addition and removal of water may be carried out either continuously or separately. The desalting and dehydration are conducted so that the conductivity of finally dehydrated water becomes preferably 300 μS/cm or less, more preferably 100 μS/cm or less and most preferably 60 μS/cm or less. Although there is no particular limitation on the lower limit of the conductivity in this case, it is usually about 5 μS/cm.

Further, for improving the state of a coated surface of the heat-developable material, particularly the photothermographic material, it is preferred that an aqueous dispersion of the organic acid silver salt is converted to a high-speed flow under high pressure, and then re-dispersed by lowering pressure to form a fine aqueous dispersion. A dispersing medium used in this case is preferably only water, but an organic solvent may be contained in an amount of 20% by weight or less.

Particles of the organic acid silver salt can be finely dispersed by mechanical dispersion in the presence of the dispersing aid using a known finely dispersing means such as a high-speed mixer, a homogenizer, a high-speed impact mill, a Banbury mixer, a homomixer, a kneader, a ball mill, a vibration ball mill, a planetary ball mill, an attriter, a sand mill, a bead mill, a colloid mill, a jet mill, a roller mill, a toron mill or a high-speed stone mill.

In dispersing the organic acid silver salt, the coexistence of a light-sensitive silver salt results in an increase in fog and significant deterioration of sensitivity. It is therefore more preferred that a light-sensitive silver salt is not substantially contained in dispersing the organic acid silver salt. In the invention, the amount of the light-sensitive silver salt contained in an aqueous dispersion is preferably 0.1 mol % or less per mol of organic acid silver salt in the dispersion, and the light-sensitive silver salt is not positively added.

For obtaining a homogeneous solid dispersion of the organic silver salt having high S/N, small particle size and no coagulation, it is preferred that large forces are uniformly exerted within the range in which particles of the organic silver salt, an image forming medium, are not damaged and not elevated high in temperature. For that purpose, a dispersing method is preferred in which the aqueous dispersion comprising the organic silver salt and an aqueous solution of the dispersing agent is converted to a high-speed flow, and then the pressure is lowered.

Dispersing apparatus used for carrying out the re-dispersing method as described above and techniques thereof are described in detail, for example, in Toshio Kajiuchi and Hiromoto Usui, “Dispersion System Rheology and Dispersing Techniques”, pages 357 to 403, Shinzansha Shuppan (1991), “Progress of Chemical Engineering”, the 24th series, pages 184 and 185, edited by Society of Chemical Engineering, Tokai Branch, Maki Shoten (1990), JP-A-59-49832, U.S. Pat. No. 4,533,254, JP-A-8-137044, JP-A-8-238848, JP-A-2-261525 and JP-A-1-94933. The re-dispersing method used in the invention is a method of sending an aqueous dispersion containing at least the organic acid silver salt into a pipe by application of pressure with a high pressure pump, then passing the dispersion through a narrow slit formed in the pipe, and causing an abrupt pressure drop in the dispersion, thereby finely dispersing the organic acid silver salt.

As to a high pressure homogenizer, it is usually considered that (a) “shearing force” developed in passing a dispersoid through a narrow slit (about 75 μm to about 350 μm) under high pressure at high speed, and (b) a further increase in cavitation force caused by a subsequent pressure drop without changing impact force developed by liquid-liquid collision or collision with a wall face in a highly pressurized narrow space bring about homogeneous efficient dispersion. Formerly, a Gorlin homogenizer has been used as an apparatus of this kind. According to this apparatus, a solution to be dispersed which is sent under high pressure is converted to a high-speed flow in a narrow slit on a column face, and collides with a surrounding wall by its force to conduct emulsification and dispersion by the resulting impact force. Means for the above-mentioned liquid-liquid collision include a Y type chamber of a microfluidizer and a spherical chamber utilizing a spherical check valve as described in JP-A-8-103642 given later, and means for liquid-wall face collision include a Z type chamber of a microfluidizer. The pressure used is generally from 100 to 600 kg/cm², and the flow rate ranges from several meters per second to 30 mm/second. For enhancing the dispersing efficiency, it is also contrived that a high speed flow portion is shaped in a saw teeth form to increase the number of collisions. Typical examples of such apparatus include a Gorlin homogenizer, a microfluidizer manufactured by Microfluidex International Corporation, a microfluidizer manufactured by Mizuho Kogyo Co., Ltd. and a nanomizer manufactured by Tokushu Kika Kogyo Co., Ltd. Such apparatus are also described in JP-A-8-238848, JP-A-8-103642 and U.S. Pat. No. 4,533,254.

The organic acid silver salt can be dispersed to a desired particle size by adjusting the flow rate, the pressure difference in the pressure drop and the number of treating times. From the viewpoints of photographic characteristics and particle size, preferably, the flow rate is from 200 m/second to 600 m/second, and the pressure difference in the pressure drop is from 900 kg/cm² to 3000 kg/cm². More preferably, the flow rate is from 300 m/second to 600 m/second, and the pressure difference in the pressure drop is from 1500 kg/cm² to 3000 kg/cm². The number of treating times can be selected as needed. Usually, it is selected from the range of 1 to 10 times. From the viewpoint of productivity, 1 to 3 times are selected. It is unfavorable from the viewpoints of dispersibility and photographic characteristics to elevate the temperature of such an aqueous dispersion to high temperature under high pressure, and at a high temperature exceeding 90° C., the particle size is liable to become large, and the fog tends to increase. It is therefore preferred that a stage prior to the above-mentioned conversion to the high-speed flow under high pressure, a stage after the pressure drop, or both of them contain cooling apparatus and the temperature of such an aqueous dispersion is kept within the range of 5° C. to 90° C. with the cooling apparatus. The temperature is more preferably kept within the range of 5° C. to 80° C., and particularly preferably within the range of 5° C. to 65° C. In particular, in the dispersion under a high pressure ranging from 1500 kg/cm² to 3000 kg/cm², it is effective to install the above-mentioned cooling apparatus. In the cooling apparatus, a double tube or a triple tube and a static mixer, a multitubular heat exchanger or a coiled heat exchanger can be appropriately selected according to its required heat exchange amount. Further, for increasing the heat exchange efficiency, the size, wall thickness and material of the tube may be suitably selected considering the pressure used. As a refrigerant for the cooler, according to heat exchange amount, there can be used a refrigerant such as well water of 20° C., cold water of 5° C. to 10° C. treated with a refrigerator, or ethylene glycol/water of −30° C. as needed.

When solid particles of the organic acid silver salts are finely dispersed using the dispersing agents, examples of the dispersing agents which can be appropriately selectively used include synthetic anionic polymers such as polyacrylic acid, copolymers of acrylic acid, maleic acid copolymers, maleic acid monoester copolymers and acryloylmethylpropanesulfonic acid copolymers; semisynthetic anionic polymers such as carboxymethyl starch and carboxymethyl cellulose; anionic polymers such as alginic acid and pectic acid; anionic surfactants described in JP-A-52-92716 and WO88/04794; compounds described in JP-A-9-179243, known anionic, nonionic and cationic surfactants, known polymers such as poly(vinyl alcohol), poly(vinylpyrrolidone), carboxymethyl cellulose, hydroxypropyl cellulose and hydroxypropylmethyl cellulose; and naturally occurring polymer compounds such as gelatin.

Although the dispersing aid is generally mixed with the organic acid silver salt in the powder or wet cake form before the dispersion, and sent into a dispersing apparatus as a slurry, it may be previously mixed with the organic acid silver salt, followed by heat treatment or treatment with a solvent to form a powder or wet cake of the organic acid silver salt. Before, after or during the dispersion, the pH may be controlled with an appropriate pH adjusting agent.

In addition to the mechanical dispersion, the organic acid silver salt may be crudely dispersed in a solvent by controlling the pH, and the pH may be changed in the presence of the dispersing aid to form fine particles. In this case, as the solvent used for the crude dispersion, there may be used an organic solvent, which is usually removed after the formation of fine particles have been completed.

The dispersion prepared can also be stored with stirring or with the viscosity increased with a hydrophilic colloid (for example, in jelly form using gelatin), for preventing precipitation of the fine particles in storing. Further, a preservative can also be added for preventing the propagation of unwanted bacteria in storing.

It is preferred that the organic acid silver salt prepared is dispersed in an aqueous solvent, followed by mixing with an aqueous solution of a light-sensitive silver salt to supply the resulting mixture as a coating solution for a light-sensitive image forming medium.

Prior to the dispersing operation, the raw material solution is crudely (previously) dispersed. As a means for crudely dispersing the raw material solution, there can be used a known dispersing means such as a high-speed mixer, a homogenizer, a high-speed impact mill, a Banbury mixer, a homomixer, a kneader, a ball mill, a vibration ball mill, a planetary ball mill, an attriter, a sand mill, a bead mill, a colloid mill, a jet mill, a roller mill, a toron mill or a high-speed stone mill. In addition to the mechanical dispersion, the raw material solution may be crudely dispersed in a solvent by controlling the pH, and the pH may be changed in the presence of the dispersing aid to form fine particles. In this case, as the solvent used for the crude dispersion, there may be used an organic solvent, which is usually removed after the formation of fine particles have been completed.

After finely dispersed, the aqueous solution of the light-sensitive silver salt is mixed to produce the coating solution for the light-sensitive image forming medium. The preparation of a photothermographic material using such a coating solution gives a photothermographic material low in haze, low in fog, and high in sensitivity. In contrast, the coexistence of the light-sensitive silver salt in the conversion to a high-speed flow under high pressure results in an increase in fog and significant deterioration of sensitivity. Further, when an organic solvent, not water, is used as a dispersing medium, the haze becomes high, the fog is increased, and the sensitivity is liable to be deteriorated. On the other hand, the use of the conversion method of converting a part of the organic silver salt in the dispersion to the light-sensitive silver salt instead of the method of mixing the aqueous solution of the light-sensitive silver salt results in a decrease in sensitivity.

In the above, the aqueous dispersion dispersed by the conversion to a high-speed flow under high pressure does not substantially contain the light-sensitive silver salt, and the content thereof is 0.1 mol % or less based on light-insensitive organic silver salt. The light-sensitive silver salt is not positively added.

The particle size (volume weighted average diameter) of the fine solid organic silver salt particle dispersion can be determined, for example, from the particle size (volume weighted average diameter) determined by irradiating laser light to the fine solid particle dispersion dispersed in a solution and determining the autocorrelation function to changes in fluctuation of its scattered light with time. The fine solid particle dispersion having an average particle size of 0.05 μm to 10.0 μm is preferred. The average particle size is more preferably from 0.1 μm to 5.0 μm, and still more preferably from 0.1 μm to 2.0 μm.

The fine solid particle dispersion of the organic silver salt preferably used in the invention comprises at least the organic silver salt and water. Although there is no particular limitation on the ratio of the organic silver salt to water, the ratio of the organic salt to the total is preferably from 5% to 50% by weight, and particularly preferably from 10% to 30% by weight. The use of the above-mentioned dispersing aid is preferred, but it is preferably used in a minimum amount within the range suitable for minimizing the particle size, specifically in an amount of 1% to 30% by weight, and particularly in an amount of 3% to 15% by weight, based on the organic silver salt.

In the invention, it is possible to produce the light-sensitive material by mixing the aqueous dispersion of the organic silver salt with the aqueous dispersion of the light-sensitive silver salt. The mixing ratio of the organic silver salt to the light-sensitive silver salt can be selected depending on the purpose. However, the ratio of the light-sensitive silver salt to the organic silver salt is preferably within the range of 1 mol % to 30 mol %, more preferably within the range of 3 mol % to 20 mol %, and particularly preferably within the range of 5 mol % to 15 mol %. In mixing, it is preferably used for adjusting the photographic characteristics that two or more kinds of aqueous dispersions of organic silver salts are mixed with two or more kinds of aqueous dispersions of light-sensitive silver salts.

In the invention, the organic silver salt can be used in a desired amount. However, they are used preferably in an amount of 0.1 g/m² to 5 g/m², and more preferably in an amount of 1 g/m² to 3 g/m², in terms of silver.

The photothermographic material of the invention contains a reducing agent for the silver ion. The reducing agents for the silver ion may be any substance for reducing a silver ion to metallic silver (preferably an organic substance). Such reducing agents are described in JP-A-11-65021, paragraph numbers 0043 to 0045, and EP-A-0803764, page 7, line 34 to page 18, line 12. In the invention, bisphenol reducing agents (for example, 1,1-bis(2-hydroxy-3,5-dimethylphenyl)-3,5,5-trimethylhexane) are particularly preferred. The amount of the reducing agent added is preferably from 0.01 g/m² to 5.0 g/m², and more preferably from 0.1 g/m² to 3.0 g/m². It is contained preferably in an amount of 5 mol % to 50 mol %, and more preferably in an amount of 10 mol % to 40 mol %, per mol of silver of a face having an image forming layer. The reducing agent is preferably contained in an image forming layer.

In the invention, the reducing agent is preferably added as a fine solid particle dispersion. The fine solid particles are finely dispersed by a known finely dispersing means (for example, a ball mill, a vibration ball mill, a sand mill, a colloid mill, a jet mill or a roller mill). Further, when the fine solid particles are dispersed, a dispersing aid may be used.

In the invention, a ultrahigh contrast enhancer may be used for formation of ultrahigh contrast images for the plate making film application. The ultrahigh contrast enhancers which can be used include but are not limited to compounds of formulas (III) to (V) specifically, compounds of “KA 21” to “KA 24”, described in Japanese Patent Application No. 11-91652.

There is no particular limitation on the halogen composition of the light-sensitive silver halides used in the invention, and silver chloride, silver chlorobromide, silver bromide, silver iodobromide and silver iodochlorobromide can be used. The distribution of the halogen composition in the grain may be uniform, or the halogen composition may vary stepwise or continuously. Further, silver halide grains having the core/shell structure can be preferably used. Double to fivefold structure type core/shell grains can be preferably used, and double to fourfold structure type core/shell grains can be more preferably used. Furthermore, a process of localizing silver bromide on the surfaces of silver chloride or silver chlorobromide grains can also be preferably used.

Methods for forming the light-sensitive silver halides are well known in the art. For example, methods described in Research Disclosure, vol. 17029 (June, 1978) and U.S. Pat. No. 3,700,458 can be used. Specifically, a method of adding a silver-supplying compound and a halogen-supplying compound to a gelatin solution or another polymer solution to prepare a light-sensitive silver halide, and then, mixing the resulting silver halide with an organic silver salt is used.

The grain size of the light-sensitive silver halide is from 0.001 μm to 0.06 μm, preferably from 0.01 μm to 0.05 μm, and more preferably from 0.02 μm to 0.04 μm. The term “grain size” as used herein means the diameter of a sphere having the same volume as that of the silver halide grain, when the silver halide grain is so-called a normal crystal such as a cube or octahedron, and is not a normal crystal, such as a spherical or rod-like grain. When the silver halide grain is a tabular grain, the grains size means the diameter of a circle image having the same area as a projected area of a main surface.

The form of the silver halide grains may be cubic, octahedral, tabular, spherical, rod-like or pebble-like. In the invention, however, cubic grains are particularly preferred. Silver halide grains having rounded corners can also be preferably used. There is no particular limitation on the surface index (mirror index) of outer surfaces of the light-sensitive silver halide grains. However, it is preferred that the ratio of the [100] face is high, the [100] face having high spectral sensitization efficiency when a spectral sensitizing dye is adsorbed thereby. The ratio is preferably 50% or more, more preferably 65% or more, and most preferably 80% or more. The ratio of the mirror index [100] face can be determined by a method described in T. Tani, J. Imaging Sci., 29, 165 (1985), utilizing adsorption dependency of the [111] face and the [100] face in adsorption of a sensitizing dye.

The light-sensitive silver halide grains contain metals or metal complexes of groups 8 to 10 in the periodic table (showing groups 1 to 18). The metals or central metals of the metal complexes of groups 8 to 10 in the periodic table are preferably rhodium, rhenium, ruthenium, osmium and iridium. These metal complexes may be used either alone or as a combination of two or more of complexes comprising the same kind or different kinds of metals. The content thereof is preferably from 1×10⁻⁹ mol to 1×10⁻³ mol, per mol of silver. These metal complexes are described in JP-A-11-65021, paragraph numbers 0018 to 0024.

Of these, the iridium compounds are preferably contained in the silver halide grains in the invention. The iridium compounds include, for example, hexachloroiridium, hexaammineiridium, trioxalatoiridium, hexacyanoiridium and pentachloronitrosyliridium. These iridium compounds are used by dissolving them in water or appropriate solvents. In order to stabilize the solution of the iridium compound, a method ordinarily frequently used, that is to say, a method of adding an aqueous solution of a hydrogen halide (e.g., hydrochloric acid, hydrobromic acid, hydrofluoric acid) or an alkali halide (e.g., KCl, NaCl, KBr, NaBr) can be used. Instead of use of the water-soluble iridium, it is also possible to add and dissolve other silver halide grains previously doped with iridium in preparing the silver halide. These iridium compounds are added preferably in an amount ranging from 1×10⁻⁸ mol to 1×10⁻³ mol, and more preferably in an amount ranging from 1×10⁻⁷ mol to 5×10⁻⁴ mol, per mol of silver halide.

Further, metal atoms which can be contained in the silver halide grains used in the invention (e.g., [Fe(CN)₆]⁴⁻), desalting methods and chemical sensitizing methods are described in JP-A-11-84574, paragraph numbers 0046 to 0050, JP-A-11-65021 and paragraph numbers 0025 to 0031.

The light-sensitive silver halide emulsions in the light-sensitive materials used in the invention may be used either alone or as a combination of two or more of them (for example, emulsions different in mean grain size, emulsions different in halogen composition, emulsions different in crystal habit, and emulsions different in the conditions of chemical sensitization). The use of plural kinds of light-sensitive silver halides different in sensitivity allows the gradation to be controlled. Techniques relating to these are described in JP-A-57-119341, JP-A-53-106125, JP-A-47-3929, JP-A-48-55730, JP-A-46-5187, JP-A-50-73627 and JP-A-57-150841. As to the difference in sensitivity, a difference of 0.2 log E or more is preferably given between the respective emulsions.

The amount of the light-sensitive silver halides added is preferably from 0.03 g/m² to 0.6 g/m², more preferably from 0.05 g/m² to 0.4 g/m², and most preferably from 0.1 g/m² to 0.4 g/m² in terms of the amount of silver coated per m² of light-sensitive material. It is preferably from 0.01 mol to 0.5 mol, more preferably from 0.02 mol to 0.3 mol, and particularly preferably from 0.03 mol to 0.25 mol, per mol of organic silver salt.

As processes for mixing the light-sensitive silver halides and the organic silver salts separately prepared and mixing conditions thereof, there are a method of mixing the separately prepared silver halide grains and organic silver salt with each other in a high-speed stirrer, a ball mill, a sand mill, a colloid mill, a vibration mill or a homogenizer, and a method of mixing the prepared light-sensitive silver halide at any timing during preparation of the organic silver salt to prepare the organic silver salt. However, there is no particular limitation thereon, as long as the effects of the invention are sufficiently manifested.

The silver halides used in the invention are preferably added to the coating solutions for image forming layers from 180 minutes before coating to immediately before coating, preferably from 60 minutes before coating to 10 seconds before coating. However, there is no particular limitation on the mixing process and the mixing conditions, as long as the effects of the invention are sufficiently manifested. Specific examples of the mixing processes include a mixing process using a tank designed so that the average residence time calculated from the flow rate of the solution added and the amount of the solution supplied to a coater becomes a desired time, and a process using static mixers described in N. Harnby, M. F. Edwards and A. W. Nienow, translated by Koji Takahashi, Liquid Mixing Techniques, chapter 8, published by Nikkan Kogyo Shinbunsha (1989).

In the invention, it is preferred that the image forming layer is formed by an aqueous coating solution. For example, a coating solution in which 30% by weight or more of a solvent is water can be used as the aqueous coating solution, and dried after coating to form the image forming layer. In this case, it is preferred that a binder of the image forming layer is contained in a state in which the binder is soluble or dispersible in an aqueous coating solution (aqueous solvent). In particular, the binder is preferably composed of a polymer latex having an equilibrium moisture content of 2% by weight or less at 25° C., 60% RH. The most preferred form is one prepared so as to give an ionic conductivity of 2.5 mS/cm or less, and methods for preparing such one include a method of purifying the polymer with a separation functional membrane after synthesis thereof.

The aqueous coating solution in which the above-mentioned polymer is soluble or dispersible is a solution in which the solvent is water or a mixture of water and 70% by weight or less of an aqueous-miscible organic solvent. The aqueous-miscible organic solvents include, for example, alcohols such as methyl alcohol, ethyl alcohol and propyl alcohol, cellosolve compounds such as methyl cellosolve, ethyl cellosolve and butyl cellosolve, ethyl acetate and dimethylformamide.

When the polymer is not dissolved thermodynamically to exist in a so-called dispersion state, the term “aqueous solvent” is also used herein.

The term “equilibrium moisture content at 25° C., 60% RH” as used herein can be expressed using the weight W1 of a polymer attaining equilibrium with moisture in the atmosphere of 25° C. and 60% RH and the weight W0 of the polymer in the absolute dry condition at 25° C. as follows:

Equilibrium Moisture Content at 25° C., 60% RH=[(W1−W0)/W0]×100(% by weight)

For the definition of the moisture content and the measuring method thereof, reference can be made to Polymer Engineering Course, 14, “Test Methods of Polymer Materials” (edited by Kobunshi Gakkai, Chijin Shokan).

The equilibrium moisture content of the binder polymers of the invention at 25° C., 60% RH is preferably 2% by weight or less, more preferably from 0.01% to 1.5% by weight, and still more preferably from 0.02% to 1% by weight.

In the invention, polymers dispersible in the aqueous solvents are particularly preferred. Examples of the dispersion states include latexes in which fine particles of solid polymers are dispersed, and dispersions of polymer molecules dispersed in a molecular state or forming micelles, both of which are preferred.

In the invention, preferred examples of such polymers include hydrophobic polymers such as acrylic resins, polyester resins, rubber resins (e.g., SBR resins), polyurethane resins, vinyl chloride resins, vinyl acetate resins, vinylidene chloride resins and polyolefin resins. The polymer may be a straight chain polymer, a branched polymer or a crosslinked polymer. Further, the polymer may be either a so-called homopolymer in which a single monomer is polymerized, or a copolymer in which two or more kinds of monomers are polymerized. The copolymer may be either a random copolymer or a block copolymer. The number average molecular weight of the polymer is preferably from 5,000 to 1,000,000, and more preferably from 10,000 to 200,000. Too low a molecular weight unfavorably results in insufficient mechanical strength of the emulsion layer, whereas too high a molecular weight causes poor film forming properties.

The term “aqueous solvent” described above means a dispersing medium comprising 30% by weight or more of water. The dispersion state may be any, for example, emulsified dispersion, micelle dispersion and a state in which a polymer having hydrophilic sites in its molecule is dispersed in a molecular state. Of these, a latex is particularly preferred.

Preferred examples of the polymer latexes include the following, wherein the polymers are represented by raw material monomers, the numerals in parentheses are percentages by weight, and the molecular weight is the number average molecular weight.

P-1: Latex of -MMA(70)-EA(27)-MAA(3)-(molecular weight: 37,000);

P-2: Latex of -MMA(70)-2EHA(20)-St(5)-AA(5)-(molecular weight: 40,000);

P-3: Latex of -St(50)-Bu(47)-MAA(3)-(molecular weight: 45,000);

P-4: Latex of -St(68)-Bu(29)-AA(3)-(molecular weight: 60,000);

P-5: Latex of -St(70)-Bu(27)-IA(3)-(molecular weight: 120,000)

P-6: Latex of -St(75)-Bu(24)-AA(1)-(molecular weight: 108,000);

P-7: Latex of -St(60)-Bu(35)-DVB(3)-MAA(2)-(molecular weight: 150,000);

P-8: Latex of -St(70)-Bu(25)-DVB(2)-AA(3)-(molecular weight: 280,000);

P-9: Latex of -VC(50)-MMA(20)-EA(20)-AN(5)-AA(5)-(molecular weight: 80,000);

P-10: Latex of -VDC(85)-MMA (5)-EA(5)-MAA(5)-(molecular weight: 67,000);

P-11: Latex of -Et(90)-MAA(10)-(molecular weight: 12,000);

P-12: Latex of -St(70)-2EHA(27)-AA(3) (molecular weight: 130,000); and

P-13: Latex of -MMA(63)-EA(35)-AA(2) (molecular weight: 33,000).

Abbreviations used in the above-mentioned structures indicate the following monomers:

MMA; Methyl methacrylate, EA; Ethyl acrylate, MAA; Methacrylic acid, 2EHA; 2-Ethylhexyl acrylate, St; Styrene, Bu; Butadiene, AA; Acrylic acid, DVB; Divinylbenzene, VC; Vinyl chloride, AN; Acrylonitrile, VDC; Vinylidene chloride, Et: Ethylene and IA; Itaconic acid

The polymers described above are commercially available, and the following polymers can be utilized. Examples of the acrylic resins include Cevian A-4635, 46583 and 4601 (the above products are manufactured by Daicel Chemical Industries, Ltd.) and Nipol Lx811, 814, 821, 820 and 857 (the above products are manufactured by Nippon Zeon Co., Ltd), examples of the polyester resins include FINETEX ES650, 611, 675 and 850 (the above products are manufactured by Dainippon Ink & Chemicals, Inc.), and WD-size and WMS (the above products are manufactured by Eastman Chemical Co.), examples of the polyurethane resins include HYDRAN AP10, 20, 30 and 40 (the above products are manufactured by Dainippon Ink & Chemicals, Inc.), examples of the rubber resins include LACSTAR 7310K, 3307B, 4700H and 7132C (the above products are manufactured by Dainippon Ink & Chemicals, Inc.) and Nipol Lx416, 410, 438C and 2507 (the above products are manufactured by Nippon Zeon Co., Ltd.), examples of the vinyl chloride resins include G351 and G576 (the above products are manufactured by Nippon Zeon Co., Ltd.), examples of the vinylidene chloride resins include L502 and L513 (the above products are manufactured by Asahi Kasei Corporation), and examples of the olefin resins include Chemipearl S120 and SA100 (the above products are manufactured by Mitsui Petrochemical Industries, Ltd.).

These polymer latexes may be used either alone or as a mixture of two or more of them as required.

As the polymer latexes used in the invention, styrene-butadiene copolymer latexes are particularly preferred. In the styrene-butadiene copolymer latex, the weight ratio of styrene monomer units to butadiene monomer units is preferably from 40:60 to 95:5. Further, the ratio of the styrene monomer units and the butadiene monomer units to the copolymer is preferably from 60% to 99% by weight. The preferred molecular weight range is the same as described above.

The styrene-butadiene copolymer latexes which can be preferably used in the invention include P-3 to P-8 described above and commercially available LACSTAR-3307B, 7132C and Nipol Lx416.

The organic silver salt-containing layer of the photothermographic material of the invention may further contain a hydrophilic polymer such as gelatin, polyvinyl alcohol, methyl cellulose or hydroxypropyl cellulose. The amount of the hydrophilic polymer added is preferably 30% by weight or less, and more preferably 20% by weight or less, base on the total binder of the organic silver salt-containing layer.

The organic silver salt-containing layer (that is to say, the image forming layer) of the photothermographic material of the invention is preferably formed using the polymer latex, and for the amount of binder contained in the organic silver salt-containing layer, the weight ratio of total binder/organic silver salt is preferably from 1/10 to 10/1, and more preferably from 1/5 to 4/1.

Further, such an organic silver salt-containing layer is also usually an image forming layer (emulsion layer) containing the light-sensitive silver halide that is the light-sensitive silver salt. In such a case, the weight ratio of total binder/silver halide is preferably from 400 to 5, and more preferably from 200 to 10.

The total binder amount of the image forming layer of the photothermographic material of the invention is preferably from 0.2 g/m² to 30 g/m², and more preferably from 1 g/m² to 15 g/m². The image forming layer may contain a crosslinking agent for crosslinking and a surfactant for improving coating properties.

In the invention, the solvent (both the solvent and the dispersing medium are referred to as the solvent herein for brevity) for a coating solution for the organic silver salt-containing layer of the light-sensitive material is an aqueous solvent containing water in an amount of 30% by weight or more. As components other than water, any water-miscible organic solvents such as methyl alcohol, ethyl alcohol, isopropyl alcohol, methyl cellosolve, ethyl cellosolve, dimethylformamide and ethyl acetate may be used. The water content of the solvents of the coating solutions is preferably 50% by weight or more, and more preferably 70% by weight or more. Preferred examples of solvent compositions include water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 (wherein the numeral values are percentages by weight), as well as water.

As sensitizing dyes applicable to the invention, sensitizing dyes can be advantageously selected which can spectrally sensitize the silver halide grains in a desired wavelength region when adsorbed by the silver halide grains, and which have spectral sensitivity suitable for the spectral characteristics of an exposure light source. The sensitizing dyes and methods for adding them are described in JP-A-11-65021, paragraph numbers 0103 to 0109, JP-A-10-186572 (compounds represented by formula (II)) and EP-A-0803764, page 19, line 38 to page 20, line 35. In the invention, the sensitizing dyes are added to the silver halide emulsions preferably from after desalting to coating, and more preferably from after desalting to before the start of chemical ripening.

Antifoggants, stabilizers and stabilizer precursors which can be used in the invention include ones described in patents cited in JP-A-10-62899, paragraph number 0070 and EP-A-0803764, page 20, line 57 to page 21, line 7.

In the invention, the antifoggant is preferably added as a fine solid particle dispersion. The fine solid particles are finely dispersed by a known finely dispersing means (for example, a ball mill, a vibration ball mill, a sand mill, a colloid mill, a jet mill or a roller mill). Further, when the fine solid particles are dispersed, a dispersing agent such as an anionic surfactant (for example, sodium triisopropyl-naphthalenesulfonate (a mixture of three isomers different in substitution positions)) may be used.

The other antifoggants include mercury (II) salts described in JP-A-11-65021, paragraph number 0113 and benzoic acid derivatives described in the same, paragraph number 0114.

In the invention, the photothermographic materials may contain azolium salts for the purpose of fog prevention. The azolium salts include compounds represented by formula (XI) described in JP-A-59-193447, compounds described in JP-B-55-12581, and compounds represented by formula (II) described in JP-A-60-153039. Although the azolium salt may be added to any site of the light-sensitive material, it is preferably added to a layer on a side having the image forming layer. More preferably, it is added to the organic silver salt-containing layer. The azolium salt may be added at any stage of the preparation of the coating solution. When added to the organic silver salt-containing layer, the azolium salt may be added at any stage from the preparation of the organic silver salt to the preparation of the coating solution, preferably from after the preparation of the organic silver salt to immediately before coating. The azolium salt may be added in any form such as a powder, a solution or a fine solid particle dispersion. Further, the azolium salt may be added as a solution in which it is mixed with another additive such as a sensitizing dye, a reducing agent or a color toning agent. In the invention, the azolium salt may be added in any amount, but preferably in an amount of 1×10⁻⁶ mol to 2 mol, and more preferably 1×10⁻³ mol to 0.5 mol, per mol of silver.

In the invention, mercapto compounds, disulfide compounds or thione compounds can be added for inhibiting or accelerating development, improving the spectral sensitizing efficiency and improving storability before and after development. Such compounds are described in JP-A-10-62899, paragraph numbers 0067 to 0069, JP-A-10-186572 (compounds represented by formula (I) and specific examples described in paragraph numbers 0033 to 0052) and EP-A-0803764, page 20, lines 36 to 56. Of these, mercapto-substituted heteroaromatic compounds are preferred.

In the invention, color toning agents are preferably added. The color toning agents are described in JP-A-10-62899, paragraph numbers 0054 to 0055 and EP-A-0803764, page 21, lines 23 to 48. Preferred are phthalazinone, phthalazinone derivatives and metal salts thereof, or derivatives of 4-(1-naphthyl)phthalazinone, 6-chloro-phthalazinone, 5,7-dimethoxyphthalazinone and 2,3-dihydro-1,4-phthalazinedione; combinations of phthalazinone and phthalic acid derivatives (e.g., phthalic acid, 4-menthyl-phthalic acid, 4-nitrophthalic acid and tetrachlorophthalic acid anhydride); phthalazines (phthalazine, phthalazine derivatives or metal salts thereof, or derivatives of 4-(1-naphthyl)phthalazine, 6-isopropylphthalazine, 6-t-butylphthalazine, 6-chloro-phthalazine, 5,7-dimethoxyphthalazine and 2,3-dihydro-phthalazine); and combinations of phthalazines and phthalic acid derivatives (e.g., phthalic acid, 4-methyl-phthalic acid, 4-nitrophthalic acid and tetrachlorophthalic acid anhydride). Combinations of phthalazines and phthalic acid derivatives are particularly preferred.

Plasticizers and lubricants which can be used in the image forming layers of photothermographic material of the invention are described in JP-A-11-65021, paragraph number 0117, ultrahigh contrast enhancers for formation of ultrahigh contrast images are described in the same, paragraph number 0118, and ultrahigh contrast accelerators are described in the same, paragraph number 0102.

The photothermographic material of the invention may be provided with a surface protective layer for preventing adhesion of the image forming layer. The surface protective layers are described in JP-A-11-65021, paragraph numbers 0119 to 0120.

As a binder for the surface protective layer of the photothermographic material of the invention, gelatin is preferred. However, the use of polyvinyl alcohol (PVA) is also preferred. The PVA includes completely saponified product PVA-105 (polyvinyl alcohol (PVA) content: 94.0% by weight or more, the degree of saponification: 98.5±0.5 mol %, sodium acetate content: 1.5% by weight or less, volatile content: 5.0% by weight or less, viscosity (4% by weight, 20° C.): 5.6±0.4 CPS), partially saponified product PVA-205 (polyvinyl alcohol (PVA) content: 94.0% by weight, the degree of saponification: 88.0±1.5 mol %, sodium acetate content: 1.0% by weight, volatile content: 5.0% by weight, viscosity (4% by weight, 20° C.): 5.0±0.4 CPS), and modified polyvinyl alcohol products MP-102, MP-202, MP-203, R-1130 and R-2105 (the above names are names of commercial products manufactured by Kuraray Co., Ltd.). The amount of polyvinyl alcohol coated (per m² of support) for every one protective layer is preferably from 0.3 mg/m² to 4.0 mg/m², and more preferably from 0.3 mg/m² to 2.0 mg/m².

The preparation temperature of the coating solutions for the image forming layers used in the invention is preferably from 30° C. to 65° C., more preferably from 35° C. to less than 60° C., and still more preferably from 35° C. to 55° C. Further, the temperature of the coating solutions for the image forming layers immediately after addition of the polymer latexes is preferably maintained at a temperature of 30° C. to 65° C. Furthermore, it is preferred that the reducing agents and the organic silver salts are mixed before addition of the polymer latexes.

The organic silver salt-containing fluids or the coating solutions for the image forming layers used in the invention are preferably so-called thixotropic fluids. The thixotropic property means the property that the viscosity decreases with an increase in the shear rate. Although any instruments may be used for measurement of the viscosity in the present invention, an RFS fluid spectrometer manufactured by Rheometrics Far East Co. is preferably used and measurements are made at 25° C. Here, for the organic silver salt-containing fluids or the coating solutions for the image forming layers used in the invention, the viscosity at a shear rate of 0.1 S⁻¹ is preferably from 400 mPa·s to 100,000 mPa·s, and more preferably from 500 mPa·s to 20,000 mPa·s. Further, the viscosity at a shear rate of 1,000 S⁻¹ is preferably from 1 mPa·s to 200 mPa·s, and more preferably from 5 mPa·s to 80 mPa·s.

Various kinds of systems exhibiting the thixotropic property are known, and described in Course: Rheology,edited by Kobunshi Kankokai, and Muroi and Morino, Polymer Latexes (published by Kobunshi Kankokai. For allowing fluids to exhibit the thixotropic property, they are required to contain many fine solid particles. Further, for enhancing the thixotropic property, it is effective to contain thickening linear polymers, to increase the aspect ratio by the anisotropic form of the fine solid particles contained, and to use alkali thickening agents and surfactants.

In the invention, the heat developable photographic emulsion is applied onto a support as one or more layers. For the single layer structure, the layer is required to contain the organic silver salt, the silver halide, a developing agent and the binder, and optionally, additional materials such as the color toning agent, an auxiliary coating agent and other auxiliary agents. For the two-layer structure, a first emulsion layer (usually, a layer adjacent to the substrate) is required to contain the organic silver salt and the silver halide, and a second layer or both layers must contain some other components. However, a single emulsion layer containing all components and the two-layer structure comprising a protective top coat is also conceivable. The structure of a multicolor-sensitive heat developable light-sensitive material may contain a combination of these two layers for each color, or all components in a single layer as described in U.S. Pat. No. 4,708,928. In the case of a multi-dye multicolor-sensitive heat developable light-sensitive material, respective emulsion layers are generally kept distinguished from each other by using a functional or nonfunctional barrier layer between respective light-sensitive layers, as described in U.S. Pat. No. 4,460,681.

The image forming layers of the photothermographic materials used in the invention can contain various kinds of dyes and pigments, from the viewpoint of improvement in a color tone, prevention of the occurrence of interference fringes and prevention of irradiation. These are described in detail in WO98/36322. Preferred examples of the dyes and pigments used in the image forming layers include anthraquinone dyes, azomethine dyes, indoaniline dyes, azo dyes, the anthraquinone-series indanthrone pigments (such as C.I. Pigment Blue 60), phthalocyanine pigments (copper phthalocyanine such as C.I. Pigment Blue 15, and nonmetal phthalocyanine such as C.I. Pigment Blue 16), the dying lake pigment-series triarylcarbonyl pigments, indigo and inorganic pigments (such as ultramarine blue and cobalt blue). These dyes and pigments may be added by any methods, for example, as solutions, emulsions or fine solid particle dispersions, or such a state that they are mordanted with polymer mordants.

Although the amount of these compounds used is determined according to the intended absorbed amount, it is preferred that they are generally used in an amount of 1 μg to 1 g, per m² of light-sensitive material.

In the invention, an antihalation layer can be provided on the side far away from a light source with respect to the image forming layer. The antihalation layers are described in JP-A-11-65021, paragraph numbers 0123 and 0124.

In the invention, it is preferred that a decoloring dye and a base precursor are added to a nonimage forming layer (light-insensitive layer) of the photothermographic material to allow the non-image forming layer to act as a filter layer or an antihalation layer. The photothermographic materials generally have nonimage forming layers, in addition to the image forming layers. The nonimage forming layers can be classified into four types according to their arrangement: (1) a protective layer provided on the image forming layer (on the side far away from the support), (2) an intermediate layer provided between the plurality of image forming layers or between the image forming layer and the protective layer, (3) an undercoat layer provided between the image forming layer and the support, and (4) a back layer provided on the side opposite to the image forming layer. The light-sensitive material is provided with the filter layer as the layer of (1) or (2), and with the antihalation layer as the layer of (3) or (4).

The decoloring dye and the base precursor are preferably added to the same nonimage forming layer, but may be separately added to two nonimage forming layers adjacent to each other. Further, a barrier layer may be disposed between two nonimage forming layers.

As a method for adding the decoloring dye to the nonimage forming layer, there can be employed a method of adding the decoloring dye to a coating solution for the nonimage forming layer as a solution, an emulsion, a fine solid particle dispersion or a polymer impregnation. The dye may be added to the nonimage forming layer using a polymer mordant. These methods are similar to methods for adding dyes to ordinary photothermographic materials. The latexes used for the polymer impregnations are described in U.S. Pat. No. 4,199,363, West German Patent Publication (OLS) Nos. 25141274 and 2541230, EP-A-029104 and JP-B-53-41091. A method for emulsifying the dye by adding it to a solution in which a polymer is dissolved is described in WO88/00723.

The amount of the decoloring dyes added is determined depending on their purpose. In general, they are used in such an amount that an optical density (absorbance) exceeding 0.1 is given when measured at a desired wavelength. The optical density is preferably from 0.2 to 2. The amount of the dyes used for obtaining such optical density is generally from about 0.001 g/m² to about 1 g/m², preferably from about 0.005 g/m² to about 0.8 g/m², and particularly preferably from about 0.01 g/m² to about 0.2 g/m².

Such decoloring of the dyes allows the optical density after heat development to decrease to 0.1 or less. Two or more kinds of decoloring dyes may be used together in heat decoloring type recording materials or the photothermographic materials. Similarly, two or more kinds of base precursors may be used together.

It is preferred that the photothermographic material of the invention is a so-called single-sided light-sensitive material having at least one silver halide emulsion-containing image forming layer on one side of the support and the back layer on the other side.

In the invention, a matte agent is preferably added for improving the transferring properties. The matte agents are described in JP-A-11-65021, paragraph numbers 0126 and 0127. When indicated by the amount coated per m² of light-sensitive material, the amount of the matte agent coated is preferably from 1 mg/m² to 400 mg/m², and more preferably from 5 mg/m² to 300 mg/m².

The matte degree of an emulsion surface may be any, as long as no stardust trouble occurs. However, the Bekk second is preferably from 50 seconds to 10,000 seconds, and particularly preferably from 80 seconds to 10,000 seconds.

In the invention, as the matte degree of the back layer, the Bekk second is preferably from 10 seconds to 1,200 seconds, more preferably from 30 seconds to 700 seconds, and still more preferably from 50 seconds to 500 seconds.

In the invention, the matte agent is preferably contained in the outermost surface layer, a layer which functions as the outermost layer, or a layer close to the outer surface, of the light-sensitive material, and preferably contained in a layer which functions as the so-called protective layer.

The back layers applicable to the invention are described in JP-A-11-65021, paragraph numbers 0128 to 0130.

A hardener may be used in each layer of the image forming layer, the protective layer and the back layer of the photothermographic material of the invention. Examples of the hardeners are described in T. H. James, THE THEORY OF THE PHOTOGRAPHIC PROCESS FOURTH EDITION, pages 77 to 87, published by Macmillan Publishing Co., Inc. (1977), and multivalent metal ions described in ibid., page 78, polyisocyanates described in U.S. Pat. No. 4,281,060 and JP-A-6-208193, epoxy compounds described in U.S. Pat. No. 4,791,042 and vinylsulfone compounds described in JP-A-62-89048 are preferably used.

The hardeners are added as solutions, and the solutions are preferably added to the coating solutions for protective layers from 180 minutes before coating to immediately before coating, preferably from 60 minutes before coating to 10 seconds before coating. However, there is no particular limitation on the mixing process and the mixing conditions, as long as the effects of the present invention are sufficiently manifested. Specific examples of the mixing processes include a mixing process using a tank designed so that the average residence time calculated from the flow rate of the solution added and the amount of the solution supplied to a coater becomes a desired time, and a process using static mixers described in N. Harnby, M. F. Edwards and A. W. Nienow, translated by Koji Takahashi, Liquid Mixing Techniques, chapter 8, published by Nikkan Kogyo Shinbunsha (1989).

Surfactants which can be used in the invention are described in JP-A-11-65021, paragraph number 0132, solvents in the same, paragraph number 0133, supports in the same, paragraph number 0134, antistatic or conductive layers in the same, paragraph number 0135, and methods for obtaining color images in the same, paragraph number 0136.

The transparent supports may be either colored with blue dyes (for example, dye-1 described in Example of JP-A-8-240877), or not colored. Undercoating techniques of the supports are described in JP-A-11-84574 and JP-A-10-186565.

The photothermographic materials are preferably of a mono-sheet type (a type in which images can be formed on the photothermographic materials without the use of other sheets, such as image receiving materials).

Anti-oxidizing agents, stabilizers, plasticizers, ultraviolet absorbers and coating aids may be further added to the photothermographic materials. Various additives are added to either the image forming layers or the nonimage forming layers. For these additives, reference can be made to WO98/36322, EP-A-803764, JP-A-10-186567 and JP-A-10-18568.

The photothermographic materials of the invention may be applied by any methods. Specifically, various coating operations including extrusion coating, slide coating, curtain coating, dip coating, knife coating, flow coating and extrusion coating using a hopper described in U.S. Pat. No. 2,681,294 are used. Extrusion coating described in Stephen F. Kistler and Petert M. Schweizer, LIQUID FILM COATING, pages 399 to 536, published by CHAPMAN & HALL (1997) or slide coating is preferably used, and slide coating is particularly preferably used. Examples of the shapes of slide coaters used in slide coating are shown in ibid., FIG. b. 1 on page 427. Two or more layers can be formed at the same time by methods described in ibid., pages 399 to 536, U.S. Pat. No. 2,761,791 and GB Patent 837,095, as so desired.

Techniques which can be used in the photothermographic materials of the invention are also described in EP-A-803764, EP-A-883022, WO98/36322, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569, JP-A-10-186570, JP-A-10-186571, JP-A-10-186572, JP-A-10-197974, JP-A-10-197982, JP-A-10-197983, JP-A-10-197985, JP-A-10-197986, JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574 and JP-A-11-65021.

Although the photothermographic materials of the invention may be developed by any methods, the photothermographic materials exposed imagewise are usually developed by elevating the temperature thereof. The developing temperature is preferably from 80° C. to 250° C., and more preferably from 100° C. to 140° C. The developing time is preferably from 1 second to 180 seconds, more preferably from 10 seconds to 90 seconds, and particularly preferably from 10 second to 40 seconds.

As the heat development system, a plate heater system is preferred, and as the heat development system according to the plate heater system, a method described in JP-A-11-133572 is preferred. In this method, a heat development apparatus giving visible images by contacting the photothermographic material having latent images formed with a heating means in a heat development unit is used, wherein the heating means comprises a plate heater, a plurality of press rollers are arranged along one side of the plate heater, facing thereto, and the photothermographic material is allowed to pass between the press rollers and the plate heater to conduct heat development. It is preferred that the plate heater is divided into 2 to 6 steps and the temperature is decreased by about 1° C. to about 10° C. at a leading edge portion thereof. Such a method is also described in JP-A-54-30032, and water and an organic solvent contained in the photothermographic material can be removed outside the system. Further, changes in the support form of the photothermographic material caused by rapid heating thereof can also be inhibited.

Although the photothermographic materials of the invention may be exposed by any methods, laser light is preferably used as an exposure light source. Preferred examples of the lasers used in the invention include a gas laser (Ar+ or He—Ne), a YAG laser, a coloring material laser and a semiconductor laser. Further, a semiconductor laser and a second harmonic generating element can also be used in combination. Preferred is a red- to infrared-emitting gas laser or a semiconductor laser.

As to the laser light, a single mode laser can be utilized. However, a technique described in JP-A-11-65021, paragraph number 0140 can be used.

The laser output is preferably 1 mW or more, and more preferably 10 mW or more. Still more preferably, a laser having a high output of 40 mW or more is used. In that case, a plurality of lasers may be combined. The diameter of the laser light can be from about 30 μm to about 200 μm by a 1/e² spot size of a Gaussian beam.

The photothermographic materials of the invention form black and white images according to silver images, and preferably used as photothermographic materials for medical diagnosis, photothermographic materials for industrial photography, photothermographic materials for printing and photothermographic materials for COM. Needless to say, these photothermographic materials can be used as masks for forming duplicated images on MI-Dup duplicating films manufactured by Fuji Photo Film Co., Ltd., for medical diagnosis, or as masks for forming images on DO-175 or PDO-100 films for dot to dot work manufactured by Fuji Photo Film Co., Ltd. or offset printing plates, for printing, based on the black and white images formed.

According to the invention, the photothermographic materials high in sensitivity and image quality and excellent in storage stability, for example, greatly decreased in the sensitivity deterioration in the storage at high temperatures, can be provided. Accordingly, the photothermographic materials of the invention are useful for medical images and photomechanical processes.

The invention will be described in more detail with reference to the following production examples and examples. The materials, reagents, ratios and procedures in the examples can be appropriately changed and modified without departing from the spirit and scope of the invention. It is therefore to be understood that the invention is not limited to the specific examples shown below.

### Production Example 1

Synthesis of Illustrative Compound (P-69)

(1) Synthesis of Intermediate (B)

Easily available compound (A) (93 g), 43 g of sodium hydroxide, 123 g of sodium chloroacetate and 10 g of potassium iodide were dissolved in 300 ml of water, followed by stirring at 80° C. for 2 hours. After the internal temperature was lowered to 30° C., 50 ml of concentrated hydrochloric acid was added thereto and stirred for some time, which allowed crystals to be precipitated. The crystals were filtered by suction, and dried to obtain 50 g of intermediate (B) as white crystals.

(2) Synthesis of Intermediate (C)

To a solution obtained by dissolving 57 g of sodium hydroxide in 500 ml of water, 33 ml of bromine was added dropwise at room temperature. Then, an aqueous solution obtained by dissolving 24 g of intermediate (B) and 8 g of sodium hydroxide in 100 ml of water was added dropwise thereto. Precipitated crystals were filtered, and the resulting crystals were added to diluted hydrochloric acid and stirred, followed by filtration. The resulting product was sufficiently washed with water and dried to obtain 30 g of intermediate (C) as white crystals.

(3) Synthesis of Intermediate (D)

Intermediate (C) (30 g) and 1 ml of DMF were dissolved in 100 ml of thionyl chloride, and stirred at 70° C. for 30 minutes. Then, excess thionyl chloride was removed by distillation under reduced pressure to obtain 31 g of intermediate (D) as white crystals.

(4) Synthesis of Illustrative Compound (P-69)

A solution obtained by dissolving 8.0 g of octylamine in 50 ml of methanol was cooled with ice, and 4.0 g of intermediate (D) was added thereto. After stirring at room temperature for 10 minutes, 50 ml of diluted hydrochloric acid was added thereto, which allowed white crystals to be precipitated. The crystals were filtered, sufficiently washed with water, and dried to obtain 3.0 g of illustrative compound (P-69) as white crystals in a 62% yield.

### Production Example 2

Synthesis of Illustrative Compound (P-24)

Illustrative compound (P-24) (3.5 g) was obtained as white crystals in an 81% yield in the same manner as with Production Example 1, with the exception that equimolar butylamine was substituted for octylamine.

### Production Example 3

Synthesis of Illustrative Compound (P-27)

To a solution obtained by dissolving 15 g of 4-aminobutanoic acid and 17 g of sodium hydrogencarbonate in a mixed solvent of 100 ml of water and 100 ml of tetrahydrofuran, 20 g of intermediate (D) was added, followed by stirring at room temperature for 5 minutes. After diluted hydrochloric acid was added to the reaction solution to neutralize it, 200 ml of water was added to precipitate crystals, which were filtered and dried. Thus, 10 g of illustrative compound (P-27) was obtained as white crystals in a 44% yield.

### Production Example 4

Synthesis of Illustrative Compound (P-12)

Illustrative compound (P-12) (13 g) was obtained as white crystals in a 60% yield in the same manner as with Production Example 3, with the exception that equimolar glycine was substituted for 4-aminobutanoic acid.

### Production Example 5

Synthesis of Illustrative Compound (P-35)

Illustrative compound (P-35) (3.7 g) was obtained as white crystals in a 79% yield in the same manner as with Production Example 1, with the exception that equimolar 6-amino-1-hexanol was substituted for octylamine.

### Production Example 6

Synthesis of Illustrative Compound (P-64)

Illustrative compound (P-64) (3.7 g) was obtained as white crystals in a 84% yield in the same manner as with Production Example 1, with the exception that equimolar pentylamine was substituted for octylamine.

### Production Example 7

Synthesis of Illustrative Compound (P-70)

Illustrative compound (P-70) (3.0 g) was obtained as white crystals in a 70% yield in the same manner as with Production Example 1, with the exception that equimolar diethylamine was substituted for octylamine.

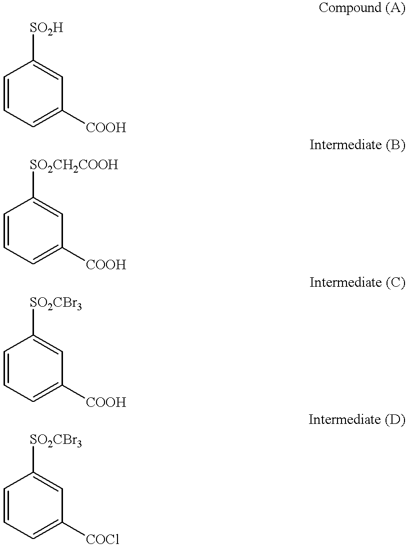

### EXAMPLE 1

Production of Photothermographic Material

(Preparation of PET Support)

Using terephthalic acid and ethylene glycol, PET having an intrinsic viscosity IV of 0.66 (measured in phenol/tetrachloroethane (6/4 in weight ratio) at 25° C.) was obtained. This was pelletized, and dried at 130° C. for 4 hours. Then, this was melted at 300° C., and extruded through a T die, followed by rapid cooling to prepare an unstretched film having such a thickness as to give a film thickness of 175 μm after heat setting.

This unstretched film was stretched lengthwise 3.3 times by use of rolls different from each other in peripheral speed, and then, stretched crosswise 4.5 times with a tenter. At this time, the temperatures were 110° C. and 130° C., respectively. Then, the stretched film was heat set at 240° C. for 20 seconds, and thereafter relaxed crosswise by 4% at the same temperature. Then, after portions chucked with the tenter were slit off, the knurl treatment was applied to both edges. Then, the resulting film was taken up at a tension of 4 kg/cm² to obtain a roll of the film having a thickness of 175 μm.

(Surface Corona Treatment)

Both surfaces of the support were treated with a Model 6KVA solid state corona treating device manufactured by Pillar Co. at room temperature at 20 m/min. Readings of current and voltage at this time revealed that the support was treated at 0.375 kV·A·min./m². The treatment frequency at this time was 9.6 kHz, and the gap clearance between an electrode and a dielectric roll was 1.6 mm.

(Preparation of Undercoated Support)

(1) Preparation of Coating Solutions for Undercoat Layers

| Formulation 1 (for Undercoat Layer on Image Forming | | |
|---|---|---|
| Layer Side) | | |
| Pesresin A-515GB manufactured | 234 | g |
| by Takamatsu Yushi Co. | | |
| (a 30 wt % solution) | | |
| Polyethylene glycol monononyl | 21.5 | g |
| phenyl ether (average ethylene | | |
| oxide number: 8.5, a 10 wt % solution) | | |
| MP-1000 manufactured by Soken | 0.91 | g |
| Chemical & Engineering Co., Ltd. | | |
| (fine polymer particles, average | | |
| particle size: 0.4 μm) | | |
| Distilled water | 744 | ml |
| Formulation 2 (for First Layer on Back Face Side) | | |
| Butadiene-styrene copolymer latex | 158 | g |
| (solid content: 40 wt %, | | |
| butadiene/styrene weight ratio: 32/68) | | |
| 2,4-Dichloro-6-hydroxy-S-triazine | 20 | g |
| sodium salt (a 8 wt % aqueous solution) | | |
| A 1-wt % aqueous solution of sodium | 10 | ml |
| laurylbenzenesulfonate | | |
| Distilled water | 854 | ml |
| Formulation 3 (for Second Layer on Back Face Side) | | |
| SnO₂/SbO (weight ratio: 9/1, | 84 | g |
| average particle size: 0.038 μm, | | |
| a 17 wt % dispersion) | | |
| Gelatin (a 10% aqueous solution) | 89.2 | g |
| Metrose TC-5 manufactured by | 8.6 | g |
| Shin-Etsu Chemical Co., Ltd. | | |
| (a 2% aqueous solution) | | |
| MP-1000 manufactured by Soken | 0.01 | g |
| Chemical & Engineering Co., Ltd. | | |
| (fine polymer particles) | | |
| A 1 wt % aqueous solution of | 10 | ml |
| sodium dodecylbenzenesulfonate | | |
| NaOH (1%) | 6 | ml |
| Proxel (manufactured by I.C.I) | 1 | ml |
| Distilled water | 805 | ml |

(Preparation of Undercoated Support)

After the above-mentioned corona discharge treatment was conducted to both faces of the 175-μm thick biaxially stretched polyethylene terephthalate support, one face (image forming layer face) was coated with the coating solution for undercoat (Formulation 1) with a wire bar so as to give a wet amount coated of 6.6 ml/m² (per one face), and dried at 180° C. for 5 minutes. Then, the back face thereof was coated with the coating solution for undercoat (Formulation 2) with a wire bar so as to give a wet amount coated of 5.7 ml/m², and dried at 180° C. for 5 minutes. The back face was further coated with the coating solution for undercoat (Formulation 3) with a wire bar so as to give a wet amount coated of 7.7 ml/m², and dried at 180° C. for 6 minutes. Thus, an undercoated support was prepared.

(Preparation of Back Face Coating Solutions)

(Preparation of Fine Solid Particle Dispersion (a) of Base Precursor)

Base precursor compound 11 (64 g), 28 g of diphenyl sulfone and 10 g of a surfactant, Demol N manufactured by Kao Corp., were mixed with 220 ml of distilled water, and the mixed solution was subjected to beads dispersion using a sand mill (a ¼ gallon sand grinder mill, manufactured by Eimex Co.) to obtain a fine solid particle dispersion (a) of the base precursor compound having an average particle size of 0.2 μm.

(Preparation of Fine Solid Particle Dispersion of Dye)

Cyanine dye compound 13 (9.6 g) and 5.8 g of sodium p-dodecylbenzenesulfonate were mixed with 305 ml of distilled water, and the mixed solution was subjected to beads dispersion using a sand mill (a ¼ gallon sand grinder mill, manufactured by Eimex Co.) to obtain a fine solid particle dispersion of the dye having an average particle size of 0.2 μm.

(Preparation of Coating Solution for Antihalation Layer)

Gelatin (17 g), 9.6 g of polyacrylamide, 70 g of the above-mentioned fine solid particle dispersion (a) of the base precursor, 56 g of the above-mentioned fine solid particle dispersion of the dye, 1.5 g of fine polymethyl methacrylate particles (average particle size: 6.5 μm), 0.03 g of benzoisothiazolinone, 2.2 g of sodium polyethylenesulfonate, 0.2 g of blue dye compound 14 and 844 ml of water were mixed to prepare a coating solution for an antihalation layer.

(Preparation of Coating Solution for Back Face Protective Layer)

A vessel was kept hot at 40° C., and 50 g of gelatin, 0.2 g of sodium polystyrenesulfonate, 2.4 g of N,N-ethylenebis (vinylsulfoneacetamide), 1 g of sodium t-octylphenoxyethoxyethanesulfonate, 30 mg of benzoisothiazolinone, 37 mg of N-perfluorooctylsulfonyl-N-propylalanine potassium salt, 0.15 g of polyethylene glycol mono(N-perfluorooctylsulfonyl-N-propyl-2-aminoethyl)ether (average degree of ethylene oxide polymerization: 15), 32 mg of C₈F₁₇SO₃K, 64 mg of C₈F₁₇SO₂N-(C₃H₇)(CH₂CH₂O)₄(CH₂)₄SO₃Na, 8.8 g of acrylic acid/ethyl acrylate copolymer (copolymerization weight ratio: 5/95), 0.6 g f Aerosol OT (manufactured by American Cyanamide), 1.8 g of a fluid paraffin emulsion as fluid paraffin, and 950 ml of water were mixed therein to prepare a coating solution for a back face protective layer.

(Preparation of Silver Halide Emulsion 1)

To 1421 ml of distilled water, 8.0 ml of a 1 wt % potassium bromide solution was added, and 8.2 ml of 1 N nitric acid and 20 g of phthalated gelatin were further added thereto. The resulting solution was maintained at 39° C. in a titanium-coated stainless steel reaction pot with stirring. On the other hand, solution A was prepared by diluting 37.04 g of silver nitrate with distilled water to 159 ml, and solution B was prepared by diluting 32.6 g of potassium bromide with distilled water to a volume of 200 ml. Solution A was wholly added at a constant flow rate for 1. minute by the control double jet method, while maintaining the pAg at 8.1. Solution B was added by the control double jet method. Then, 30 ml of a 3.5 wt % aqueous solution of hydrogen peroxide was added, and 36 ml of a 3 wt % aqueous solution of benzimidazole was further added. Then, solution A2 was prepared by diluting solution A again with distilled water to 317.5 ml, and solution B2 was prepared by dissolving tripotassium iridate hexachloride in solution B so as to finally give a concentration of 1×10⁻⁴ mol per mol of silver, and diluting the resulting solution with distilled water to 400 ml, twice the volume of solution B. Solution A2 was wholly added at a constant flow rate for 10 minute by the control double jet method, while maintaining the pAg at 8.1. Solution B2 was added by the control double jet method. Thereafter, 50 ml of a 0.5 wt % solution of 5-methyl-2-mercaptobenzimidazole in methanol was added, and the pAg was increased to 7.5 with silver nitrate. Then, the pH was adjusted to 3.8 using 1 N sulfuric acid, and stirring was stopped, followed by sedimentation, desalting and washing. Then, 3.5 g of deionized gelatin was added, and 1 N sodium hydroxide was added to adjust the solution to pH 6.0 and pAg 8.2, thereby preparing a silver halide dispersion.

Grains in the resulting silver halide emulsion were cubic pure silver bromide grains (corners thereof were somewhat rounded) having an average equivalent sphere diameter of 0.06 μm and a coefficient of variation of equivalent sphere diameters of 18%. The grain size was determined from a volume weighted average of 1000 grains under an electron microscope. The [100] face ratio of the grains determined by the Kubelka-Munk method was 85%.

The above-mentioned emulsion was maintained at 38° C. with stirring, and 0.035 g of benzoisothiazoline (a 3.5 wt % methanol solution) was added thereto. After 40 minutes, a solid dispersion of spectral sensitizing dye A (in an aqueous solution of gelatin) was added in an amount of 5×10⁻³ mol per mol of silver, and after 1 minute, the temperature was elevated to 47° C. After 20 minutes, sodium benzenethiosulfonate was added in an amount of 3×10⁻⁵ mol per mol of silver, and after further 2 minutes, tellurium sensitizer B was added in an amount of 5×10⁻⁵ mol per mol of silver, followed by ripening for 90 minutes. Just before the termination of the ripening, 5 ml of a 0.5 wt % solution of N,N′-dihydroxy-N″-diethylmelamine in methanol was added, and the temperature was lowered to 31° C. Then, 5 ml of a 3.5 wt % solution of phenoxyethanol in methanol was added, 5-methyl-2-mercaptobenzimidazole was added in an amount of 7×10⁻³ mol per mol of silver, and 1-phenyl-2-heptyl-5-mercapto-1,3,4-triazole was added in an amount of 6.4×10⁻³ mol per mol of silver. Thus, silver halide emulsion 1 was prepared.

(Preparation of Silver Halide Emulsion 2)

A cubic pure silver bromide grain emulsion was prepared in the same manner as with the preparation of silver halide emulsion 1, with the exception that the liquid temperature in forming the grains was changed from 39° C. to 47° C. The grains had an average equivalent sphere diameter of 0.08 μm and a coefficient of variation of equivalent sphere diameters of 15%. Similarly to silver halide emulsion 1, precipitation/desalting/washing/dispersion were carried out. Further, spectral sensitization, chemical sensitization and addition of 5-methyl-2-mercaptobenzimidazole and 1-phenyl-2-heptyl-5-mercapto-1,3,4-trazole were conducted in the same manner as with the preparation of silver halide emulsion 1, with the exception that the amount of spectral sensitizing dye A added was changed to 4.5×10⁻³ mol per mol of silver. Thus, silver halide emulsion 2 was obtained.

(Preparation of Silver Halide Emulsion 3)

A cubic pure silver bromide grain emulsion was prepared in the same manner as with the preparation of silver halide emulsion 1, with the exception that the liquid temperature in forming the grains was changed from 39° C. to 25° C. The grains had an average equivalent sphere diameter of 0.03 μm and a coefficient of variation of equivalent sphere diameters of 15%. Similarly to silver halide emulsion 1, precipitation/desalting/washing/dispersion were carried out. Further, spectral sensitization, chemical sensitization and addition of 5-methyl-2-mercaptobenzimidazole and 1-phenyl-2-heptyl-5-mercapto-1,3,4-trazole were conducted in the same manner as with the preparation of silver halide emulsion 1, with the exception that the amount of spectral sensitizing dye A added was changed to 7×10⁻³ mol per mol of silver. Thus, silver halide emulsion 3 was obtained.

(Preparation of Silver Halide Emulsion 4)

A cubic pure silver bromide grain emulsion was prepared in the same manner as with the preparation of silver halide emulsion 1, with the exception that the liquid temperature in forming the grains was changed from 39° C. to 32° C. The grains had an average equivalent sphere diameter of 0.045 μm and a coefficient of variation of equivalent sphere diameters of 15%. Similarly to silver halide emulsion 1, precipitation/desalting/washing/dispersion were carried out. Further, spectral sensitization, chemical sensitization and addition of 5-methyl-2-mercaptobenzimidazole and 1-phenyl-2-heptyl-5-mercapto-1,3,4-trazole were conducted in the same manner as with the preparation of silver halide emulsion 1, with the exception that the amount of spectral sensitizing dye A added was changed to 6×10⁻³ mol per mol of silver. Thus, silver halide emulsion 4 was obtained.

(Preparation of Mixed Emulsion A for Coating Solution)

Mixed solution A for a coating solution was prepared using the above-mentioned silver halide emulsions 1 to 4. The mixing ratios of the silver halide emulsions were as shown in Table 1. Benzothiazolium iodide was added to emulsion A as a 1 wt % aqueous solution in an amount of 7×10⁻³ mol per mol of silver.

(Preparation of Scaly Fatty Acid Silver Salt)

Behenic acid (trade name: Edenor C22-85R) (87.6 g) manufactured by Henckel Co., 423 ml of distilled water, 49.2 ml of a 5 N aqueous solution of NaOH and 120 ml of tert-butanol were mixed, and stirred at 75° C. for 1 hour to conduct the reaction, thereby obtaining a solution of sodium behenate. Separately, 206.2 ml of an aqueous solution containing 40.4 g of silver nitrate (pH 4.0) was prepared, and the temperature thereof was kept at 10° C. A reaction vessel in which 635 ml of distilled water and 30 ml of tert-butanol were placed was kept at a temperature of 30° C., and the sodium behenate solution previously prepared and the aqueous solution of silver nitrate were wholly added thereto at a constant flow rate for 62 minutes and 10 seconds and for 60 minutes, respectively. At this time, only the aqueous solution of silver nitrate was added for 7 minutes and 20 seconds after the start of addition of the aqueous solution of silver nitrate. Thereafter, addition of the sodium behenate solution was started, and only the sodium behenate solution was added for 9 minute and 30 seconds after addition of the aqueous solution of silver nitrate was completed. At this time, the temperature in the reaction vessel was adjusted to 30° C., and the temperature of the outside was controlled so that the liquid temperature was maintained constant. Further, a pipe of an addition system of the sodium behenate solution was insulated with steam trace, and the opening of a valve for steam was controlled so as to give a liquid temperature of 75° C. at an outlet of a tip of an addition nozzle. Further, a pipe of an addition system of the aqueous solution of silver nitrate was insulated by circulating cool water in the outer space of a double pipe. A position of adding the sodium behenate solution and a position of adding the aqueous solution of silver nitrate were arranged symmetrically centered on a stirring shaft, and at such a height that they did not come into contact with the reaction solution.

After addition of the sodium behenate solution was completed, the solution was allowed to stand with stirring at a temperature left as it was for 20 minutes, and then, the temperature was lowered to 25° C. Then, solid matter was filtered by suction filtration, and washed with water until a filtrate showed a conductivity of 30 μS/cm. Thus, a fatty acid silver salt was obtained. The resulting solid matter was stored as a wet cake without drying it.

The shape of the resulting silver behenate particles was evaluated taking electron photomicrographs. As a result, the silver behenate particles were scaly crystals having a of 0.14 μm, b of 0.4 μm and c of 0.6 μm in average, an average aspect ratio of 5.2, an average equivalent sphere diameter of 0.52 μm, and a coefficient of variation of equivalent sphere diameters of 15% (a, b and c are specified in this specification).

To a wet cake corresponding to 100 g of dried solid matter, 7.4 g of polyvinyl alcohol (trade name: PVA-217) and water were added to make the total weight 385 g, and the resulting mixture was preliminarily dispersed with a homomixer.

Then, the original fluid preliminarily dispersed was treated three times with a dispersing device (trade name: Microfluidizer M-110S-EH, manufactured by Microfluidex International Corporation, using a G10Z interaction chamber), adjusting its pressure to 1750 kg/cm². Thus, a dispersed product of silver behenate was obtained. For the cooling operation, coiled heat exchangers were each mounted in front of and behind the interaction chamber, and the temperature of a refrigerant was controlled thereby to set the dispersing temperature to 18° C.

(Preparation of 25 Wt % Dispersion of Reducing Agent)

Water (16 kg) was added to 10 kg of 1,1-bis(2-hydroxy-3,5-dimethylphenyl)-3,5,5-trimethylhexane and 10 kg of a 20 wt % aqueous solution of modified polyvinyl alcohol (Poval MP203, manufactured by Kuraray Co., Ltd.), and sufficiently mixed to prepare a slurry. This slurry was supplied with a diaphragm pump, and dispersed in a horizontal sand mill (UVM-2, manufactured by Eimex Co.) filled with zirconia beads having an average diameter of 0.5 mm for 3 hours and 30 minutes. Then, 0.2 g of benzoisothiazolinone sodium salt and water were added thereto so as to give a reducing agent concentration of 25% by weight, thus obtaining a reducing agent dispersion. Reducing agent particles contained in the reducing agent dispersion thus obtained had a median diameter of 0.42 μm and a maximum particle size of 2.0 μm or less. The resulting reducing agent dispersion was filtered through a polypropylene filter having a pore size of 10.0 μm to remove foreign materials such as dust, and then stored.

(Preparation of 25 Wt % Dispersion of Compound Represented by Formula (1))

Water (195.5 g) was added to 100 g of compound of formula (1), 100 g of a 20 wt % aqueous solution of modified polyvinyl alcohol (Poval MP203, manufactured by Kuraray Co., Ltd.) and 4.5 g of a 20 wt % aqueous solution of sodium triisopropylnaphthalenesulfonate, and sufficiently mixed to prepare a slurry. This slurry was placed in a ¼ G vessel together with 960 g of zirconia silicate beads having an average diameter of 0.5 mm, and dispersed in a sand grinder mill (manufactured by Eimex Co.) for 5 hours. Then, 100 ppm of benzoisothiazolinone sodium salt was added thereto, thereby obtaining a fine solid particle dispersion. Fine particles contained in the a fine solid particle dispersion thus obtained had a median diameter ranging from 0.35 μm to 0.45 μm and a maximum particle size of 2.0 μm or less. The resulting dispersion was filtered through a polypropylene filter having a pore size of 3.0 μm to remove foreign materials such as dust, and then stored.

(Preparation of 5 Wt % Solution of Phthalazine Compound)

Modified polyvinyl alcohol (Poval MP203, manufactured by Kuraray Co., Ltd.) (8 kg) was dissolved in 174.57 kg of water, and then, 3.15 kg of a 20 wt % aqueous solution of sodium triisopropylnaphthalenesulfonate and 14.28 kg of a 70 wt % aqueous solution of 6-isopropylphthalazine were added thereto, thereby preparing a 5 wt % solution of 6-isopropylphthalazine.

(Preparation of 20 Wt % Dispersion of Pigment)

Water (250 g) was added to 64 g of C.I. Pigment Blue 60 and 6.4 g of Demol N manufactured by Kao Corp., and sufficiently mixed to prepare a slurry. The slurry was placed in a vessel together with 800 g of zirconia beads having an average diameter of 0.5 mm, and dispersed with a dispersing device (a ¼ G sand grinder mill, manufactured by Eimex Co.) for 25 hours to obtain a pigment dispersion. Pigment particles contained in the pigment dispersion thus obtained had an average particle size of 0.21 μm.

(Preparation of 40 Wt % Latex of SBR)

Ultrafiltration (UF)-purified SBR latex was obtained in the following manner.

The following SBR latex was diluted with distilled water ten times, and diluted and purified using a module for UF-purification, FSO3-FC-FUYO3A1 (Daisen Membrane System Co.) until the ion conductivity reached 1.5 mS/cm. Then, Sandet-BL manufactured by Sanyo Chemical Industries, Ltd. was added thereto so as to give a content of 0.22% by weight. Further, NaOH and NH₄ were added so as to give a molar ratio of Na⁺ ions to NH₄⁺ ions of 1:2.3, thereby adjusting the pH to 8.4. At this time, the latex concentration was 40% by weight.

(SBR Latex: Latex of -St(68)-Bu(29)-AA(3)-)

Average particle size: 0.1 μm, concentration: 45% by weight, equilibrium moisture content at 25° C. and 60% RH: 0.6% by weight, ion conductivity: 4.2 mS/cm (the ion conductivity was measured for a stock solution (40%) of the latex at 25° C. by use of a CM-30S conductivity meter manufactured by Towa Denpa Kogyo Co.), and pH: 8.2.

(Preparation of Coating Solution for Emulsion Layer (Image Forming Layer))

The 20 wt% aqueous dispersion of the pigment obtained above (1.1 g), 103 g of the organic acid silver dispersion, 5 g of the 20 wt % aqueous solution of polyvinyl alcohol PVA-205 (manufactured by Kuraray Co., Ltd.), 25 g of the above-mentioned 25 wt % reducing agent dispersion, the compound represented by formula (1) (the kind and amount (“mol/mol-Agβ” of the amount added described in Table 1 represents the number of moles added per mol of the total of the silver halide and the organic acid silver) are shown in Table 1), 106 g of the 40 wt % ultrafiltration (UF)-purified, pH-adjusted SBR latex and 18 ml of the 5 wt % solution of the phthalazine compound were mixed, and 10 g of mixed silver halide emulsion A was sufficiently mixed with the mixture to prepare a coating solution for an emulsion layer. The solution was supplied to a coating die as such so as to give 70 ml/m² and applied.

The viscosity of the above-mentioned coating solution for the emulsion layer was measured with a B type viscometer (No. 1 rotor, 60 rpm) of Tokyo Keiki Co., Ltd., and it was 85 (mPa·s) at 40° C.

The viscosity of the coating solution at 25° C. measured using an RFS fluid spectrometer manufactured by Rheometrics Far East Co. was 1500, 220, 70, 40 and 20 (mPa·s) at shear rates of 0.1, 1, 10, 100 and 1000 (1/sec.), respectively.

(Preparation of Coating Solution for Emulsion Face Intermediate Layer)

To 772 g of a 10 wt % aqueous solution of polyvinyl alcohol PVA-205 (manufactured by Kuraray Co., Ltd.), 5.3 g of the 20 wt % pigment dispersion and 226 g of a 27.5 wt % solution of methyl methacrylate/styrene/butyl acrylate/hydroxyethyl methacrylate/acrylic acid copolymer (copolymerization weight ratio: 64/9/20/5/2) latex, 2 ml of a 5 wt % aqueous solution of Aerosol OT (manufactured by American Cyanamide) and 10.5 ml of a 20 wt % aqueous solution of diammonium phthalate were added. Then, water was added to bring the total weight to 880 g to form a coating solution for an intermediate layer, which was supplied to a coating die so as to give 10 ml/m². The viscosity of the coating solution measured with a B type viscometer (No. 1 rotor, 60 rpm) at 40° C. was 21 (mPa·s).

(Preparation of Coating Solution for First Emulsion Face Protective Layer)

Inert gelatin (64 g) was dissolved in water, and 80 g of a 27.5 wt % solution of methyl methacrylate/styrene/butyl acrylate/hydroxyethyl methacrylate/acrylic acid copolymer (copolymerization weight ratio: 64/9/20/5/2) latex, 23 ml of a 10 wt % solution of phthalic acid in methanol, 23 ml of a 10 wt % aqueous solution of 4-methylphthalic acid, 28 ml of 1 N sulfuric acid, 5 ml of a 5 wt % aqueous solution of Aerosol OT (manufactured by American Cyanamide), 0.5 g of phenoxyethanol and 0.1 g of benzoisothiazolinone were added thereto. Then, water was added thereto to bring the total weight to 750 g, thus preparing a coating solution, which was mixed with 26 ml of 4 wt % chrome alum in a static mixer just before coating, and supplied to a coating die so as to give 18.6 ml/m². The viscosity of the coating solution measured with a B type viscometer (No. 1 rotor, 60 rpm) at 40° C. was 17 (mPa·s).

(Preparation of Coating Solution for Second Emulsion Face Protective Layer)

Inert gelatin (80 g) was dissolved in water, and 102 g of a 27.5 wt % solution of methyl methacrylate/styrene/butyl acrylate/hydroxyethyl methacrylate/acrylic acid copolymer (copolymerization weight ratio: 64/9/20/5/2) latex, 3.2 ml of a 5 wt % solution of N-perfluorooctylsulfonyl-N-propylalanine potassium salt, 32 ml of a 2 wt % aqueous solution of polyethylene glycol mono(N-perfluorooctylsulfonyl-N-propyl-2-aminoethyl)ether (average degree of ethylene oxide polymerization: 15), 23 ml of a 5 wt % solution of Aerosol OT (manufactured by American Cyanamide), 4 g of fine polymethyl methacrylate particles (average particle size: 0.7 μm), 21 g of fine polymethyl methacrylate particles (average particle size: 6.4 μm), 1.6 g of 4-methylphthalic acid, 4.8 g of phthalic acid, 44 ml of 1 N sulfuric acid and 10 mg of benzoisothiazolinone were added thereto. Then, water was added thereto to bring the total weight to 650 g, and the resulting solution was mixed with 445 ml of an aqueous solution containing 4% by weight of chrome alum and 0.67% by weight of phthalic acid in a static mixer just before coating to prepare a coating solution for a surface protective layer, which was supplied to a coating die so as to give 8.3 ml/m². The viscosity of the coating solution measured with a B type viscometer (No. 1 rotor, 60 rpm) at 40° C. was 9 (mPa·s).

(Preparation of Photothermographic Materials)

For each of photothermographic materials, the back face side of the above-mentioned undercoated support was simultaneously coated with a coating solution for an antihalation layer so as to give an amount of solid matter coated of the fine solid particle dye of 0.04 g/m² and with a coating solution for a protection layer so as to give an amount of gelatin coated of 1.7 g/m² in multiple layers, followed by drying to prepare an antihalation back layer.

Then, an emulsion layer (silver amount coated of silver halide: 0.14 g/m²), an intermediate layer, a first protective layer and a second protective layer were simultaneously coated in multiple layers from the undercoat face on the side opposite to the back face in this order by the slide speed coating system to prepare each photothermographic material sample.

The coating was carried out at a speed of 160 m/min., and the clearance between the tip of the coating die and the support was set to 0.14 mm to 0.28 mm. The coating width was adjusted so as to extend 0.5 mm to each of the right and left with respect to the extrusion slit width of the coating solution, and the pressure in a vacuum chamber was set to a pressure 392 Pa lower than atmospheric pressure. In that case, the support was controlled by handling and the temperature and humidity so as not to be charged, and static was further eliminated from the support by ionic air just before coating. In a subsequent chilling zone, the coating solutions were cooled by blowing thereon air having a dry-bulb temperature of 18° C. and a wet-bulb temperature of 12° C. for 30 seconds. Then, dry air having a dry-bulb temperature of 30° C. and a wet-bulb temperature of 18° C. was blown thereon for 200 seconds in a helical floating type drying zone. Thereafter, the sample was passed through a drying zone of 70° C. for 20 seconds, and subsequently through a drying zone of 90° C. for 10 seconds, followed by cooling to 25° C. Thus, the solvents contained in the coating solutions were evaporated. The average speed of air blown on film surfaces of the coating solutions in the chilling zone and the drying zones was 7 m/second.

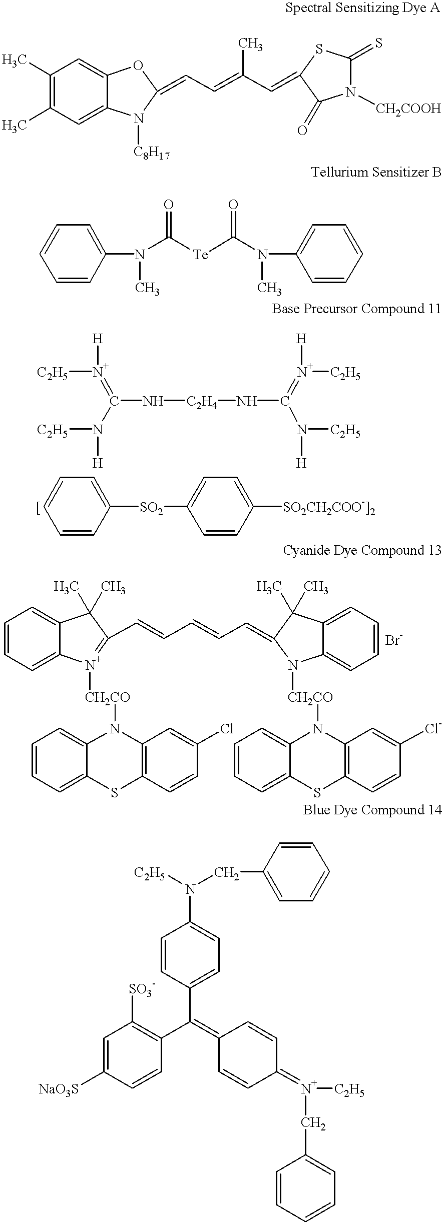

(Evaluation of Photographic Characteristics)

Using a Fuji medical dry laser imager FM-DPL (equipped with a 660-nm semiconductor laser having a maximum output of 60 mW (IIIB)), the photographic materials were exposed and heat developed (at about 120° C.). The resulting images were evaluated with a densitometer.

The sensitivity was evaluated by the reciprocal of a ratio of an exposure giving a density 1.0 higher than fog (Dmin), and indicated by the relative value, taking the sensitivity of the fresh sample of run number 1 as 100. From the viewpoint of practicability, the sensitivity is required to be from 95 to 105.

(Evaluation of Virgin Stock Storability of Photothermographic Materials)

Each photothermographic material sample was conditioned under the circumstances of 25° C. and 30% RH, and cut to a sheet form. Three sheets thereof were stacked and placed in a moisture-proof bag. Three sets of such bags were prepared for each sample, and stored (1) at 60° C. for 7 hours, and (2) at 40° C. for 3 days. Then, the above-mentioned exposure and heat development were conducted for the photothermographic material before storage and the intermediate (second) sheet of the three stacked sheets after storage, and the photographic characteristics thereof were evaluated. The experiment under the conditions of (1) 60° C. for 7 hours was made assuming the inside of an automobile in the daytime in the height of summer.

Results thereof are shown in Tables 1 and 2. In the tables, the numbers of the compounds represented by formula (1) correspond to the numbers of the compounds whose structures are shown above as preferred compounds. Structures of the other polyhalogen compounds are shown below. The organic polyhalogen compounds were dispersed in the same manner as with the compounds represented by formula (1). However, organic polyhalogen compound-4 was added after neutralization with an equimolar aqueous solution of sodium hydroxide. The results showed that the photothermographic materials of the invention was high in sensitivity and excellent in storability in the undeveloped state.

TABLE 1

| | Mixing Ratio of Silver Halide (%) | | | | | | | |
|---|---|---|---|---|---|---|---|---|
| | (Average Gain Size in Parentheses) | | | | | | | |
| | Emul- | Emul- | Emul- | Emul- | Compound of Formula | | Organic Polyhalogen | |
| | sion 1 | sion 2 | sion 3 | sion 4 | (1) | | Compound (OPHC) | |
| Run | (0.06 | (0.08 | (0.03 | (0.045 | | Amount Added | | Amount Added |
| No. | μm) | μm) | μm) | μm) | Kind | (mol/mol-Agβ) | Kind | (mol/mol-Agβ) |
| 1 | 100 | — | — | — | P-24 | 0.7 × 10⁻¹ | OPHC*-1 | 0.6 × 10⁻¹ |
| 2 | — | 100 | — | — | P-24 | 0.7 × 10⁻¹ | OPHC-1 | 0.6 × 10⁻¹ |
| 3 | — | — | 100 | — | P-24 | 0.7 × 10⁻¹ | OPHC-1 | 0.6 × 10⁻¹ |
| 4 | — | — | — | 100 | P-24 | 0.7 × 10⁻¹ | OPHC-1 | 0.6 × 10⁻¹ |
| 5 | — | 100 | — | — | OPHC-1 | 1.3 × 10⁻¹ | — | — |
| 6 | 100 | — | — | — | OPHC-1 | 1.3 × 10⁻¹ | — | — |
| 7 | — | — | 100 | — | OPHC-1 | 1.3 × 10⁻¹ | — | — |
| 8 | 100 | — | — | — | OPHC-2 | 0.7 × 10⁻¹ | OPHC-1 | 0.6 × 10⁻¹ |
| 9 | 50 | — | 50 | — | P-24 | 0.7 × 10⁻¹ | OPHC-1 | 0.6 × 10⁻¹ |
| 10 | — | — | — | 100 | P-80 | 0.7 × 10⁻¹ | OPHC-1 | 0.6 × 10⁻¹ |
| 11 | — | — | — | 100 | P-109 | 0.7 × 10⁻¹ | OPHC-1 | 0.6 × 10⁻¹ |
| 12 | — | — | — | 100 | P-51 | 0.7 × 10⁻¹ | OPHC-1 | 0.6 × 10⁻¹ |
| 13 | — | — | — | 100 | P-64 | 0.7 × 10⁻¹ | OPHC-1 | 0.6 × 10⁻¹ |
| 14 | — | — | — | 100 | P-24 | 1.3 × 10⁻¹ | — | — |
| 15 | — | — | — | 100 | P-24 | 0.7 × 10⁻¹ | OPHC-2 | 0.6 × 10⁻¹ |
| 16 | — | — | — | 100 | P-24 | 0.7 × 10⁻¹ | OPHC-3 | 0.6 × 10⁻¹ |
| 17 | — | — | — | 100 | P-24 | 1.2 × 10⁻¹ | OPHC-4 | 0.1 × 10⁻¹ |
| 18 | — | — | — | 100 | P-24 | 0.7 × 10⁻¹ | P-64 | 0.6 × 10⁻¹ |

*OPHC: Organic Polyhalogen Compound

TABLE 2

| | | | | Evaluation of Virgin | | | Evaluation of Virgin | | | |
|---|---|---|---|---|---|---|---|---|---|---|
| | | | | Stock Storability 1 | | | Stock Storability 2 | | | |
| | Fresh Photographic | | | (Stored at 40° C. for 3 | | | (Stored at 60° C. for 7 | | | |
| | Characteristics | | | days) | | | hours) | | | |
| Run | | Sensi- | | | Sensi- | | | Sensi- | | |
| No. | Dmin | tivity | Dmax | Dmin | tivity | Dmax | Dmin | tivity | Dmax | Note |
| 1 | 0.15 | 100 | 3.4 | 0.15 | 100 | 3.4 | 0.15 | 99 | 3.4 | Invention |
| 2 | 0.15 | 93 | 3.4 | 0.15 | 93 | 3.4 | 0.15 | 91 | 3.4 | Comparison |
| 3 | 0.15 | 104 | 3.4 | 0.15 | 104 | 3.4 | 0.16 | 103 | 3.3 | Invention |
| 4 | 0.15 | 102 | 3.4 | 0.15 | 102 | 3.4 | 0.15 | 101 | 3.3 | Invention |
| 5 | 0.15 | 93 | 3.4 | 0.15 | 92 | 3.3 | 0.16 | 90 | 3.2 | Comparison |
| 6 | 0.15 | 102 | 3.4 | 0.15 | 95 | 3.2 | 0.15 | 80 | 2.9 | Comparison |
| 7 | 0.15 | 105 | 3.4 | 0.15 | 88 | 2.9 | 0.16 | 65 | 2.7 | Comparison |
| 8 | 0.15 | 103 | 3.4 | 0.15 | 96 | 3.2 | 0.15 | 82 | 2.9 | Comparison |
| 9 | 0.15 | 102 | 3.4 | 0.15 | 102 | 3.4 | 0.15 | 102 | 3.4 | Invention |
| 10 | 0.15 | 102 | 3.4 | 0.15 | 102 | 3.4 | 0.15 | 101 | 3.3 | Invention |
| 11 | 0.15 | 101 | 3.4 | 0.15 | 101 | 3.4 | 0.15 | 100 | 3.3 | Invention |
| 12 | 0.15 | 101 | 3.4 | 0.15 | 101 | 3.4 | 0.15 | 100 | 3.3 | Invention |
| 13 | 0.15 | 102 | 3.4 | 0.15 | 102 | 3.4 | 0.15 | 101 | 3.3 | Invention |
| 14 | 0.15 | 101 | 3.4 | 0.23 | 103 | 3.4 | 0.23 | 102 | 3.3 | Comparison |
| 15 | 0.15 | 100 | 3.4 | 0.15 | 100 | 3.4 | 0.15 | 102 | 3.4 | Invention |
| 16 | 0.15 | 99 | 3.4 | 0.15 | 100 | 3.4 | 0.15 | 102 | 3.4 | Invention |
| 17 | 0.15 | 99 | 3.4 | 0.15 | 99 | 3.4 | 0.15 | 99 | 3.4 | Invention |
| 18 | 0.15 | 100 | 3.4 | 0.15 | 101 | 3.4 | 0.15 | 101 | 3.4 | Invention |

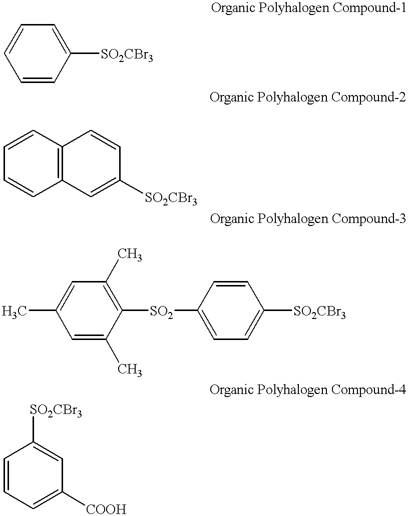

### EXAMPLE 2

In the manufacturing process of sample number 205 described in Example 2 of JP-A-11-174621, the above-mentioned heterocyclic aromatic mercapto compound (A) was used in place of compound A, and a fine solid particle dispersion of the above-mentioned compound P-24 or the above-mentioned compound 1 for comparison was used in place of tribromomethylphenylsulfone to prepare two kinds of photothermographic materials. The amount of heterocyclic aromatic mercapto compound (A) added and the amount of compound P-24 or compound 1 for comparison added were the same as those of the sample of run number 1 or 4 in Table 1. The photographic characteristics and the storability were evaluated in the same manner as with Example 1. As a result, similarly to the results shown in Table 1, the sample in which compound P-24 was used gave better results than the sample in which composition 1 for comparison was used.

### EXAMPLE 3

In the manufacturing process of level 2 described in Example 1 of JP-A-2000-347345, the above-mentioned heterocyclic aromatic mercapto compound (A) was used in place of compound B, and the above-mentioned compound P-24 or the above-mentioned compound 1 for comparison was used in place of compound I-39 to prepare two kinds of photothermographic materials. The amount of heterocyclic aromatic mercapto compound (A) added and the amount of compound P-24 or compound 1 for comparison added were the same as those of the sample of run number 1 or 4 in Table 1. The photographic characteristics and the storability were evaluated in the same manner as with Example 1. As a result, similarly to the results shown in Table 1, the sample in which compound P-24 was used gave better results than the sample in which composition 1 for comparison was used.

While the invention has been described in detail and with reference to specific embodiments thereof, it will be apparent to one skilled in the art that various changes and modifications can be made therein without departing from the spirit and scope thereof.

What is claimed is:

1. A photothermographic material comprising a support having provided on one side thereof at least one light-sensitive silver halide, light-insensitive organic silver salt, reducing agent for a silver ion and binder, in which said light-sensitive silver halide has an average grain size of 0.001 μm to 0.06 μm, and said material comprises at least two kinds of organic polyhalogen compounds, at least one of which is an organic polyhalogen compound represented by the following formula (1): 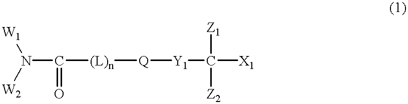
wherein Z₁ and Z₂ each independently represents a halogen atom, X₁ represents a hydrogen atom or an electron attractive group, Y₁ represents a —CO— group or an —SO₂— group, Q represents an arylene group or a divalent heterocyclic group, L represents a connecting group, W₁ and W₂ each independently represents a hydrogen atom, an alkyl group, an aryl group or a heterocyclic group, and n represents an integer of 0 or 1.

2. The photothermographic material according to claim 1, wherein a layer containing said organic polyhalogen compound represented by formula (1) is formed by an aqueous coating solution, and said organic polyhalogen compound represented by formula (1) is added to the aqueous coating solution as an aqueous dispersion.
